(19) United States
(12) Patent Application Publication
(10) Pub. No.: US 2019/0287178 A1
(43) Pub. Date: Sep. 19, 2019

(54) PERSONALIZED INVESTMENT PORTFOLIO

(71) Applicant: Francesco Maria Gaini, Milan (IT)

(72) Inventor: Francesco Maria Gaini, Milan (IT)

(21) Appl. No.: 15/938,739

(22) Filed: Mar. 28, 2018

Related U.S. Application Data
(63) Continuation-in-part of application No. 15/708,395, filed on Sep. 19, 2017, now abandoned.
Application No. 15/708,395 is a continuation-in-part of application No. 15/260,690, filed on Sep. 9, 2016, now abandoned.
(60) Provisional application No. 62/216,315, filed on Sep. 9, 2015.

(51) Int. Cl. G06Q 40/06; G06Q 10/06

(52) U.S. Cl. CPC G06Q 40/06; G06Q 10/0635

(57) ABSTRACT

A method for establishing a personalized investment portfolio comprising the steps of starting from a client's investor behavior and experience establishing a client profile based on questions regarding the client's behavior of daily life and investment approach and experience to provide a behavioral profile; constructing a computer program model to determine optimal asset class allocation for each client profile covering a wide range of assets, including real estate, insurance, arts and traditional financial asset classes as a holistic asset allocation; and establishing.a model of a personalized ranking of financial investment products for a client investor, based on product characteristics and investor profile with a best fit investment program.

This application is a continuation in part of U.S. Ser. No. 15/708,395, filed Sep. 19, 2017 which is a continuation-in part of non-provisional patent application U.S. Ser. No. 15/260,690, filed Sep. 9, 2016 with priority to provisional patent application U.S. Ser. No. 62/216,315, filed on Sep. 9, 2015, the disclosure of which are incorporated herein by reference thereto.

### FIELD OF THE INVENTION

This invention relates to preparing and personalizing financial portfolios specifically based on investor behavior and experience.

### BACKGROUND

Investment portfolios are usually haphazardly arranged and sometimes tailored to specific investor profiles but there are little, if any, highly organized methods of specifically tailoring investment financial portfolios based on the build-up of optimal product allocations based on specific answers to questionnaires provided to investors and the formulation of an investment model and computer program based thereon.

### SUMMARY OF THE INVENTION

This invention comprises a system and method for providing a personalized investment portfolio for a client with computerized implementation and is based on the following method steps and, criteria.

The present invention further comprises a data processing system method of establishing a personalized financial portfolio based on investor behavior and experience.

Generally, the invention comprises several overall primary or main steps to build the optimal product allocation for an investor or client.

A first step comprises establishing a client profile, based on a series of questions regarding his (the term “his” is not gender specific and is used herein for convenience) behavior, covering both his daily life and his investment approach and experience (behavioral profile).

A second step comprises a model to determine the optimal asset class allocation for each client profile, covering a wide range of assets, including real estate, insurance, arts and traditional financial asset classes (termed, holistic asset allocation).

A third and final step of the method comprises a model of establishing a personalized ranking of financial investment products for an investor, based on product characteristics and investor profile (termed best fit investment).

The entire method operates within a telecommunication network architecture of the client-server type which is dynamically updated based on market trends and product performance and evolution.

The invention also comprises a computer program on a non-transitory medium, which can be loaded directly into a working memory of a server processing system, to implement the steps of the methods of the invention, under the control of the server system, when the program is run on the server processing system.

The invention also comprises a computer program product comprising a substrate which can be read by a computer, on which substrate the program is stored. It also comprises a program which can be loaded directly into a working memory of a server processing system to implement the steps of the methods of the invention when the program is run on the server processing system.

The invention further comprises a data-processing system for establishing a personalized ranking of financial investment products for an investor, as well as a data-processing system for establishing a personalized composition of a portfolio of shares in financial and non-financial assets for an investor.

The following is an expanded and more detailed enumeration of intermediate steps of the present method (prefaced by a descriptor of “BestFit” as shorthand notation for the present method and system):

The following ten steps outline non-limiting procedures, mechanisms, and actionable insights for the recipients of BestFit generated client information and which includes multi-disciplinary behavioral science, neuroeconomics and psychometrics, to explore the invisible universe of the unconscious part of the brain with indirect, non-invasive questions.

### Step 1

BestFit selects a set of Predictors (i.e. character traits and personal preferences) from its Predictor Universe which is deemed to be most important to the specific business segment BestFit is being deployed in. Based on the priorities of each business using BestFit, a sub-set of predictors is chosen. This defines the custom-tailored basis of the ultimate user profile.

### Step 2

A team of behavioral science specialists and commercial experts suggest charming, non-invasive, non-offensive questions.
BestFit employs 3 distinct question types:
   Dichotomous Questions
   Multiple Choice Questions
   Rating Scale Question

### Step 3

The basis of BestFit is the indirect approach in gaining insights of the user's personality, by creating charming, non-invasive, inoffensive and discrete questions. This creates user engagement and avoids gaming of answers (i.e. the deliberate distortion of answers based on the image the person wants to create of him-/herself rather than his/her true personality).

### Step 4

BestFit's algorithms are assigned to each single answer. A Predictor based user profile can therefore be established with as little as one answered question. The answering of additional questions is supplemental and improves the quality of the Predictor results.

### Step 5

Psychometrics determines how many answers are required to assure a reliable viability of a Predictor variable.

### Step 6

Sample personality traits focus on:
Decision making style
   Fact based: sale focuses on pricing, product features and competitor rankings
   Emotional: focus on aesthetics, telling a story
Trend follower vs. individualist: “most sold products” vs. “new and exclusive items”
Decision Autonomy:
   By himself
   Open to advice/influenced by others
Fee sensitivity: focus on pricing
Curiosity:
   Open to new ideas and products
   Frequent communication welcome
Locus of Control
   Internal: of the opinion that he is in control
   External: very sensitive to outside forces

Psychological interpretation of a user leads to highly differentiated communication

### Step 7

Profiled by BestFit's technology, a company's customer base can be effectively and accurately clustered and segmented. This is especially helpful for designing effective marketing campaigns (e.g. lead lists, top 20% least fee sensitive), develop demand driven products and services, and maximize pricing efficiencies (e.g. dynamic pricing). BestFit data intelligence allows companies to create profile-based model personae on true data sets.

### Step 8

Profiling data can be either stored in the cloud or on A server of the client. Data can be extracted and integrated with other information sources.

### Step 9

Use of data for action items include
Marketing campaigns: individual approach for each customer segment established through BestFit
   Communication channel:
      Tech savvy: instant messenger communication
      Non-tech savvy, non-involved: postal letter with follow up call
      Social: personal phone call
   Customer personality type specific wording and content:
      Tech savvy: product feature oriented
      Individualist: “exclusive”, “unique”
      Trend follower: “most popular”, honorable mentioning in magazines, testimonials
   Customer personality adapted offerings
      Low fee sensitivity: premium products
      High fee sensitivity: product offerings with steep discounts
      Tech savvy: self-directed online only products
      Non tech-savvy: products with personal service
Customized shop for each client, instead of a standardized product show case
Sales support: use of trigger points specific for each customer
   Trend follower: “best-selling product”
   High price sensitivity: “best value”
   Individualist: “limited edition”
Personalized service for ALL clients based on BestFit data rather than through resource intensive personal relationship building.
Creation of products and services: Deep understanding of customer wants and needs allows for the creation of products which match client characteristics (e.g. development of discounted online insurance policies for tech savvy customers)
Effective acquisition of new clients: focus on social media active customers to recommend/like company products and encourage referrals within their friend base
Increase lifetime value of client assessment through optimized client engagement and strengthening of loyalty to and identification with the company/brand

The following discussion, examples and drawing provide additional explanation for the present invention with the drawings, in which:

### SHORT DESCRIPTION OF THE DRAWINGS

FIG. 1 is a spread sheet showing a scoring matrix for evaluation of a client;

FIG. 2 is a table of parameters of a sample test with distribution of gender, age, level of education, profession and geographical area in Italy, the site of the test;

FIGS. 3A and 3B are a bar chart and tabulation respectively of opinion results in the sample test of “pleasantness of filling in the questionnaire” used in the same according to enumerated parameters of the test takers;

FIGS. 4A and 4B are a pie chart and tabulation respectively of time required to fill out the questionnaire used in FIGS. 3A and 3B;

FIGS. 5A-E are chart and tabulated results of the questionnaire as evaluated with respect to Risk Inclination of those answering the questionnaire;

FIGS. 6A-G are chart and tabulated results of the questionnaire with respect to future Temporal Horizon considerations, recognitions and profiles.

FIGS. 7A-H are chart and tabulated results of the questionnaire with respect to Financial Experience and Recognition and Profiles;

FIGS. 8A-D are tabulated results of Behaviour (British and European spelling) by risk inclination with respect to the questionnaire;

FIGS. 9A-F are tabulated results of Personality Attitudes by risk inclination with respect to the questionnaire;

FIG. 10 is a test results chart and tabulated questionnaire responses validating the method; and

FIG. 11 is a test result overview with evaluations of the criteria of the questionnaire.

### DETAILED DESCRIPTION

The method and system herein comprises steps involving several parts:
A) an input questionnaire,
B) an output array of parameters,
C) a scoring matrix,
D) a set of model portfolios,
E) a fund selector,
F) a personalized reporting and
G) an alert triggering system to different areas of the bank (as applicable).

The process herein starts with collecting information about the client, in order to define his or her investment profile. The main data source is a questionnaire which comprises a set of questions regarding habits, lifestyle and personality. A sample version thereof includes 37 salient questions (based on a Eurocentric investor), as follows. Variations are possible but with the questions centering around similar themes:

A) Sample Questionnaire

A—You will read a set of sentences regarding your personality, please give a score on how much you agree with them on a scale from very high to very low (VH, H, M, L, VL):

1. I like trying new experiences

2. I love the excitement that I feel when I compete

3. The more people I have around me, the more comfortable I feel

4. I always pay attention to the judgment of other people

5. Keeping up with the times is important. As soon as a new tech gadget is on the market, I must buy it

6. There is nothing worse than losing

7. I feel uncertain about my financial future

8. I like my routine; therefore, I always eat in the same restaurant

9. I always check and compare prices before a purchase

10. I always keep myself informed about current events.

B—You will read a set of sentences regarding your personality, please give a score if True or False:

11. When I hear about a new restaurant, I must try it.

12. I like leading and taking responsibility for others.

13. I have a structured way of life, and a code of values that I strictly follow.

14. I like sharing my ideas with others. That's why I am active in one or more associations.

15. I have a collection (coins, stamps . . . ).

16. Based on my income, my expenses are high.

17. It is unlikely that my working life will improve.

18. I like keeping updated about the financial markets, and personally judging the performance of my investments.

19. When a new technological gadget is available on the market:
a) I order it in advance. I must be the first to have the new gadget, it does not matter how expensive it is.
b) I wait for some weeks to let others try first, and I will decide if I want to buy it based on their reviews
c) I never buy technological gadgets as soon as they are available on the market. I can purchase them the following year for half of their current price.
d) I do not care about technological gadgets

20. Holidays are the perfect time for:
a) Some action! I enjoy doing outdoor/indoor extreme sports when going on holiday.
c) Some relax at home with my family.
d) Visiting European capitals that are rich of history and culture
e) Reaching exotic destinations
f) Reaching my favorite tourist resort

21. When I buy a new garment
a) I delegate someone else to buy it without caring about too much.
b) I ask the sales assistant which item of clothing is the trendiest.
c) I search for the piece of clothing that has the best price/quality ratio.
d) I do not care about how I get dressed. I choose the first item of clothing that I see.
e) I pay great attention to my clothes. I must love them, they should fit me accurately, they must be of my favorite brand.

22. It's time to book summer holidays! I set my trip out by
a) Planning each detail personally
b) Controlling holiday packages on internet
c) Delegating my travel agency to plan everything.

23. I have 2 weeks of holidays. I . . .
a) go to a resort with an “all-inclusive” holiday package
b) go to my house in the countryside/seaside/mountains
c) go on a cruise
d) go on a desert island, as Robinson Crusoe
e) go camping
f) Travel with my yacht or sailing boat
g) Other/stay at home

24. I have won the lottery for 3 million euros! The first thing that I do is
a) I go shopping (clothes, car, jewels . . . )
b) I deposit the money in my bank account.
c) I pay my debts off (mortgages, loans . . . )
d) I invest in financial products
e) I invest in a productive activity (bar, restaurant, shop . . . )
f) I buy a new house 25. I am investing 300,000 euros. I choose an investment that lasts for
a) Less than 1 year
b) Between 1 and 3 years
c) Between 3 and 5 years
d) Beyond 5 years

26. I love shopping

Give a score on a scale between 0 and 100 where Yes, absolutely=100%/Not at all=0%

27. The market has gone through a crisis and my portfolio lost 30% of its value. Consequently . . .
a) I sell everything immediately. Things can only get worse.
b) I wait for a recovery. Subsequently, I sell everything.
c) I double my investment so as to take advantage of the possible recovery.

28. The market has performed outstandingly in the last year and my portfolio has gained 30%. Hence . . .
a) I sell everything to realize the gain.
b) I maintain my position unchanged.
c) I invest more money in the same portfolio.

29. If had to choose among the three following lotteries, I would choose
a) 50% of probability of winning 140 euros and 50% of probability of winning nothing
b) 50% of probability of winning 80 euros and 50% of probability of winning 20 euros
c) 100% of probability of winning 30 euros

30. Evaluating if an investment is successful requires time. I can wait for
a) Less than 1 year
b) Between 1 and 3 years
c) Between 3 and 5 years
d) More than 5 years

31. I have planned my next important investment (house, honeymoon, retiring from work. . . . ) for
a) Less than 1.year
b) Between 1 and 3 years
c) Between 3 and 5 years
d) Beyond 5 years 32. I have an account of the following social networks (select all the ones where you have an account)
a) Linkedln
b) Twitter
c) Skype
d) Instagram
e) None of these

33. I usually share a new photo or statement
a) Continuously
b) Every hour
c) Once a day
d) Once a week or less
e) Never

34. I check my WhatsApp/Facebook messages
a) Continuously
b) Every 10 minutes
c) Every hour
d) Twice a day
e) Everyday
f) I do not use WhatsApp/Facebook

35. I think that TripAdvisor (or similar services) . . .
a) is fantastic. I always check it before choosing an hotel or a restaurant
b) is fantastic. I always use it and I often write a review
c) I do not trust reviews. I prefer verifying things myself
d) What is TripAdvisor?

36. My opinion on newsletter is:
a) I often subscribe to newsletters: I like being informed about the most recent offers
b) I do not like them. I do not want spam in my inbox
c) I select accurately the types of newsletter that I subscribe. I do not like being disturbed too often
d) I do not know what newsletters are.

37. I prefer staying informed by looking at-online or newspapers
a) International news and events on international channels/foreign websites
b) International news and events on national websites/channels
c) Local news and national politics
d) Sportscast
e) News about entertainment, gossip
b)The output parameters:

After collecting information from the questionnaire and alternative data sources, the algorithm has to turn this information into a synthetic value, which represents the profile of the client.

There are several ways to do so, and in one embodiment a multidimensional profile approach is used. The output of the algorithm is, in fact, an array of values, including multiple different parameters. In a version, the parameters are the following:

1. Risk Propensity (1 low, 5 high)

2. Time Horizon (years) 3. Sophistication

4. Stress Management

5. Optimism

6. Sociability

7. Proactivity

8. Competitiveness

9. Engagement

10. Decision Making Style

11. Decision Autonomy

12. Social Network presence

13. KI Fashion

14. KI Shopping

15. KI Sports

16. KI International

17. KI Collections

18. Tech Friendliness

19. Curiosity

20. Focus on savings

Once an answer is chosen, the matrix is reduced by eliminating the rows of the not chosen answers. When all questions have been answered, the total sum of each column will provide a value (lower than 1) for each level of the output parameters. The algorithm picks the values with the higher value to assign the fmal scoring to each parameter.

The Definition of the 12 Main Profiles

Once the set of scores is defined, the algorithm picks one of twelve main profiles, which were defined statistically after testing the questionnaire on a set of 524 subjects. These profiles individuate twelve typical

The algorithm may assign different values to each of these parameters. Most of them can have a low or high value, some can have one of two values (such as Anxious/Relaxed), Risk Propensity has a wider scale from low to high and Time Horizon a scale from short to long.

c) The Scoring System

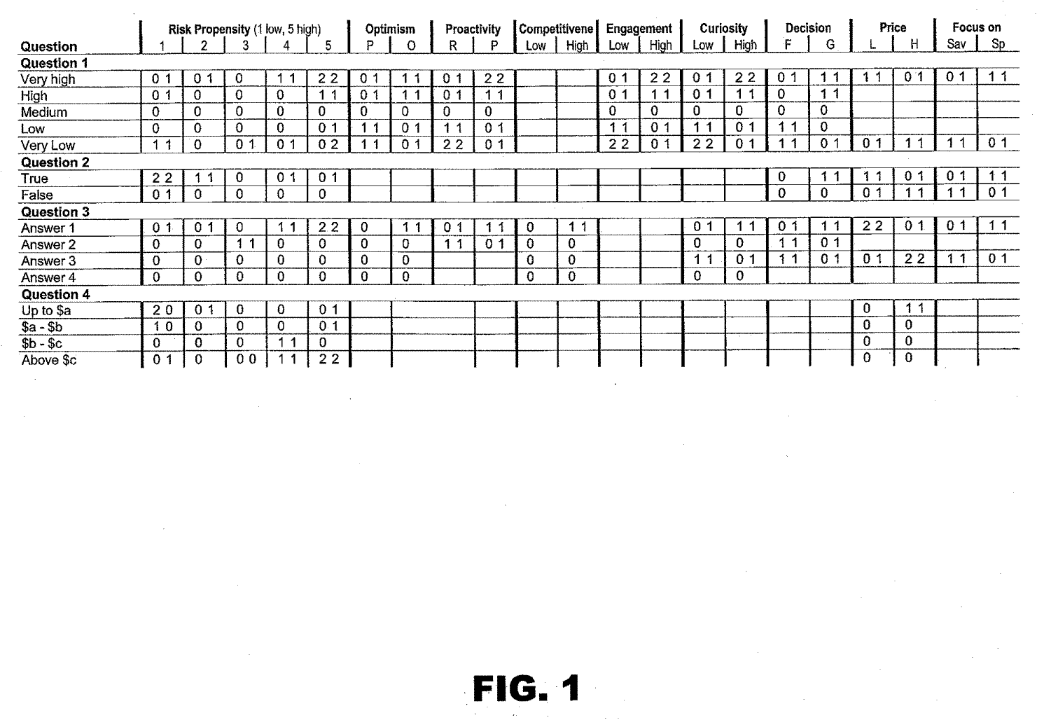

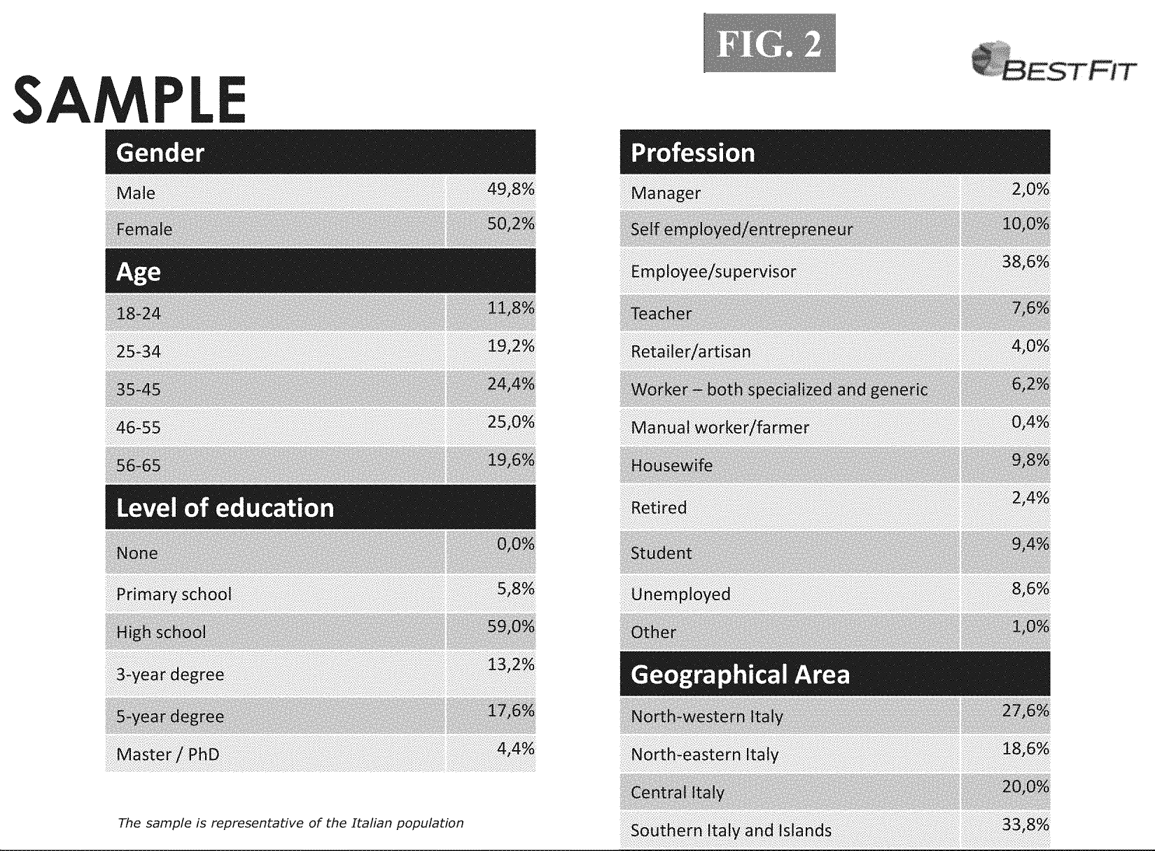

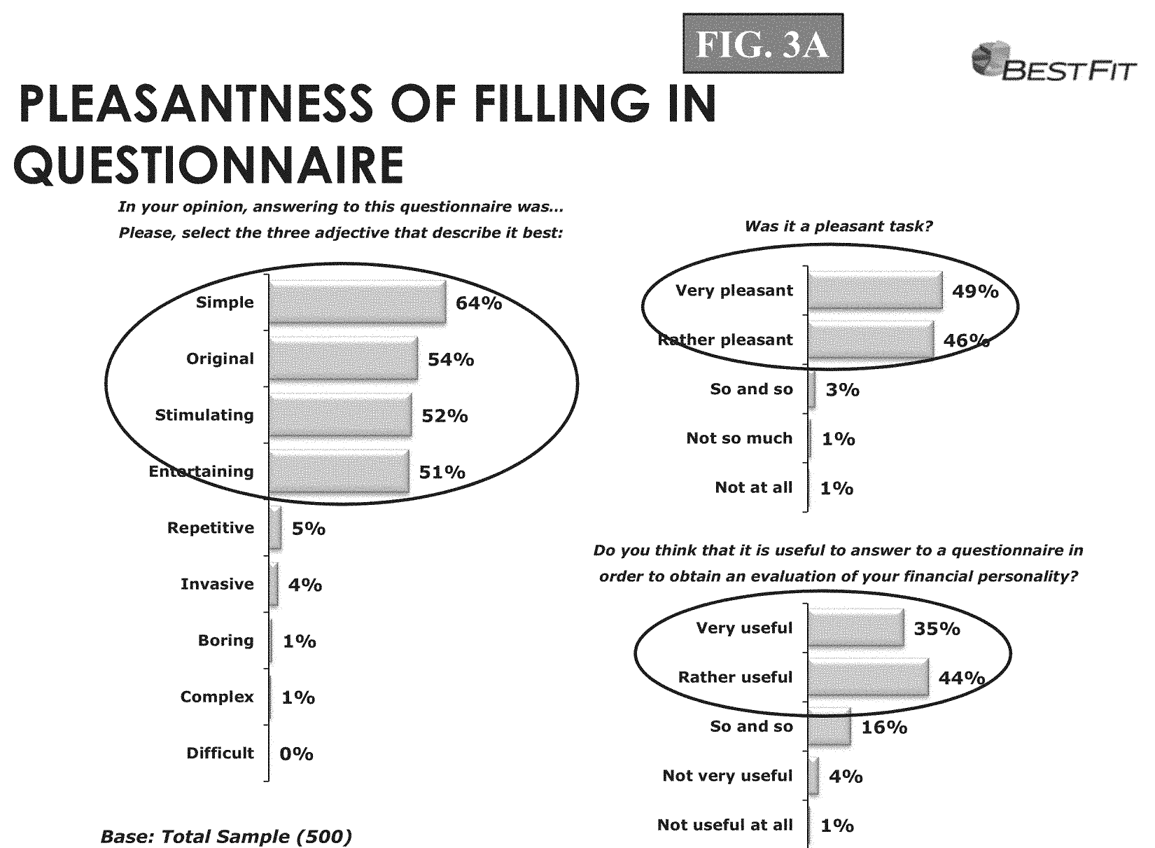

Each answer can affect several parameters. This is done through a scoring matrix, with rows corresponding to all the possible answers to the questionnaire and columns corresponding to all the values of the output parameters. Every element of the scoring matrix is either a zero or a fraction. FIG. 1 is an example of the scoring matrix.

[symbol]

personas with specific behaviour characteristics. The personas can be matched with the already existing risk categories of the bank, or kept as a standalone profiling. Each profile gets access to a subset of financial instruments (selected as further explained below) which are suitable with its risk profile, time horizon and behaviour characterization.

D) The Model Portfolios

In order to estimate the strategic model portfolios a model is used which is able to combine Bayesian models and heuristic models. Specifically, it uses the Black-Litterman model to estimate the expected returns, and the intra-group boundaries for the subsequent optimization. This choice was made in order to avoid the typical limits of the Markowitz optimization, i.e. instability of portfolios, high sensitivity to input errors, unreasonable corner portfolios.

The Black-Litterman model starts from the market-neutral portfolio. Generally, it is the portfolio that replicates the market capitalization weights of the chosen asset classes. The main idea is, in fact, that an investor without any views about the future evolution of the markets should rationally replicate the market neutral portfolio.

Through a reverse optimization process, the model estimates the expected returns that would justify the composition of the market neutral portfolio. The following formula synthetizes the process:

Π=r_{f}+(λΣ)*W_{MN}

where:
Π is the equilibrium expected returns vector;
r_{f} is the risk free rate (on an annual basis);
λ is the risk aversion coefficient: it indicates the extra return that the investor needs to accept one extra unit of risk;
Σ: is the variance-covariance matrix of historical returns of the benchmarks;
W_{MN} is the vector of the market capitalization weights.

Using a risk aversion coefficient X in conjunction with a Correlation Matrix provides Equilibrium expected returns which leads to a Prior returns distribution:

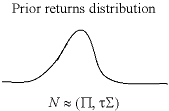

The value of A can be estimated through the following:

$$λ = \frac{{E ( R )}_{MN} - {r}_{f}}{{σ}_{MN}^{2}}$$

where:
E(R)_{MN}−r_{f} Is the expected risk premium of the market neutral portfolio;
σ_{MN}² is the expected variance of the market neutral portfolio.

The-expected returns just computed can then be adjusted according to a series of views given by market analysts.

The views have to be expressed on a specific time horizon and can be of various types:
absolute views on a single asset class (ex. positive view on European stocks);
absolute views on macro asset classes or groups (ex. negative view on the bond market);
relative views (ex. the European stock market will over-perform the American stock market);
relative views on macro asset classes or groups (ex. the stock market will strongly over-perform the bond market).
   The views have to be given together with a confidence interval, expressed as a measure of how much the analyst believes in the given view.

The view Q in conjunction with the views uncertainty Ω provides a views distribution:

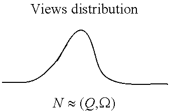

The two distributions so calculated have to be combined to achieve the posterior returns distribution. This can be done through the formula:

R_{BL}=[(τΣ)⁻¹+P^{T} Ω⁻¹ P]⁻¹[(τΣ)⁻¹Π+P^{T} Ω⁻¹ Q]

where:
P is a matrix which links the asset classes and the views. It has the same number of rows as the number of views and the same number of columns as the number of asset classes. In case of absolute views on every asset class it is the identity matrix;
Σ is the variance-covariance matrix of the asset class returns;
is a scalar that allows to transform the variance-covariance matrix of the returns into the variance-covariance of expected returns. It is always lower than 1;
Q is the vector which identifies the views;
Π is a matrix which identifies the degree of confidence of the views.

Combining the Prior Returns distribution

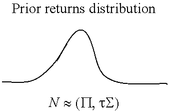

with the Views Distribution

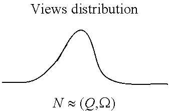

provides a Posterior returns distribution

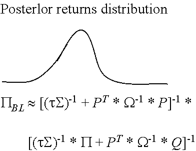

Once we have the expected returns and the variance-covariance matrix, it is possible to proceed to the optimization of the efficient frontier, following the standard Markowitz model, but with the adding of intra-groups limitations. Specifically, the model uses:
intra-group limits (European stock market cannot exceed a certain percentage of the stocks);
absolute weight limits (Global bonds cannot exceed a certain percentage of the portfolio); absolute group weights limit (stocks cannot exceed a certain percentage of the portfolio); relative weight limits (weight of stocks cannot be more than double than the weight of bonds).

E) The Fund Selector

The mutual funds can be ranked according to the main valuation parameters especially:
performance parameters (sharpe, information ratio, etc);
risk parameters (volatility, maximum drawdown, recovery time, beta);
advanced parameters (alpha, TeV, Sortino);
asymmetry parameters (kurtosis, skewness, DSR, Beta bull, Beta bear).

According to the client profile, the algorithm changes the weights of the product parameters, which are used to build a product ranking.

For example, for a more risk tolerant client, the performance parameters will have a greater weight than the risk parameters, while for a short time horizon-client the maximum drawdown and the recovery time will be taken into account with a greater weight.

The outcome of the algorithm is not only a synthesis of whole questionnaire, but each question has its own single role in the calculation. For example, the answer to the question “I always check and compare prices before buying something” gives information about whether the fees of a financial product are a very relevant element for the client or not and their weighting in the ranking calculation can be modified accordingly.

F) Personalized Reporting

The output of the algorithm can be used not only to optimize the client's financial portfolio, but also to deeply personalize the overall commercial service that he is getting.

The present algorithm is made to give to the client what he really wants; even with the periodic reporting of the portfolio performance, not all clients are the same.

In fact, according to the client's profile, the algorithm sets the periodicity of the report (weekly, monthly, quarterly) and which content the report should focus on. A customer with a greater level of Autonomy could appreciate a less frequent update, while a client with a smaller level of Autonomy might want to be ensured every week of the performance of his portfolio. A client who likes to take decisions according on a wide data check base, will get a more detailed report.

G) Alert Triggering Through Bank Divisions (as Applicable)

The present algorithm is moving in three directions, one towards the optimization of the client portfolio, the second through the personalization of the service, and the third through notifications to different bank divisions.

In fact, at every step, the algorithm can trigger some “opportunity alerts” to different offices of the bank to let them interact with the customer. For example, if the questionnaire underlines that a client is very risk oriented and entrepreneurial, the private equity division will be alerted to contact him and present more investments.

The questionnaire contains several questions related to shopping behaviour. Determined answers trigger the alert of offering a credit card service, others to offer a loan, a sports insurance, etc.

In the above sample, 500 interviews representative of an Italian population with a bank account and owning financial investments or wishing to do so in the future.

In evaluating the results, results on bases smaller than 80 cases were considered to be less reliable and results on bases small tha 25 were considered only as a qualitative.

The tables in the Figures which are shown as being circled highlight results with such circling which are statistically significant (95% level probability). All other results are considered in line with the total sample ones.

Based on cultural considerations with respect to an Italian mind set, a mark of 7 is a good result and a mark of 8 is an extraordinary test result.

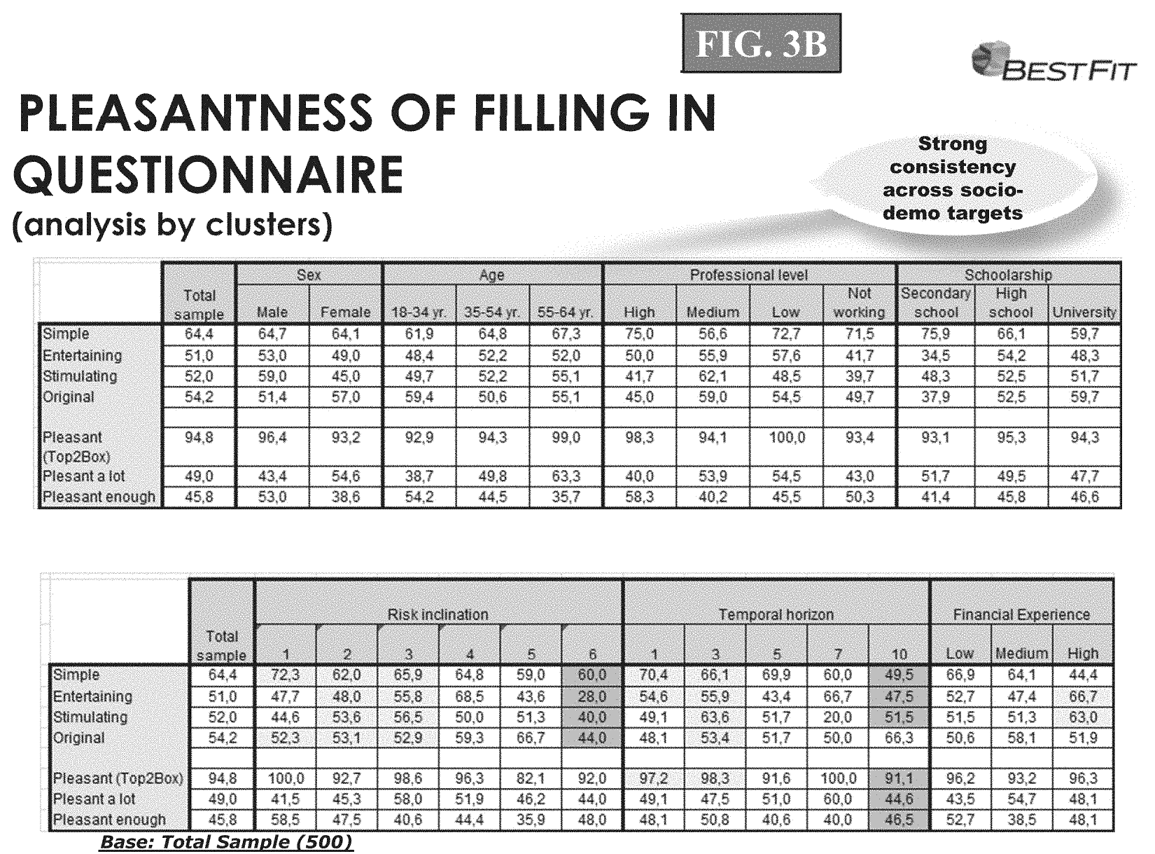

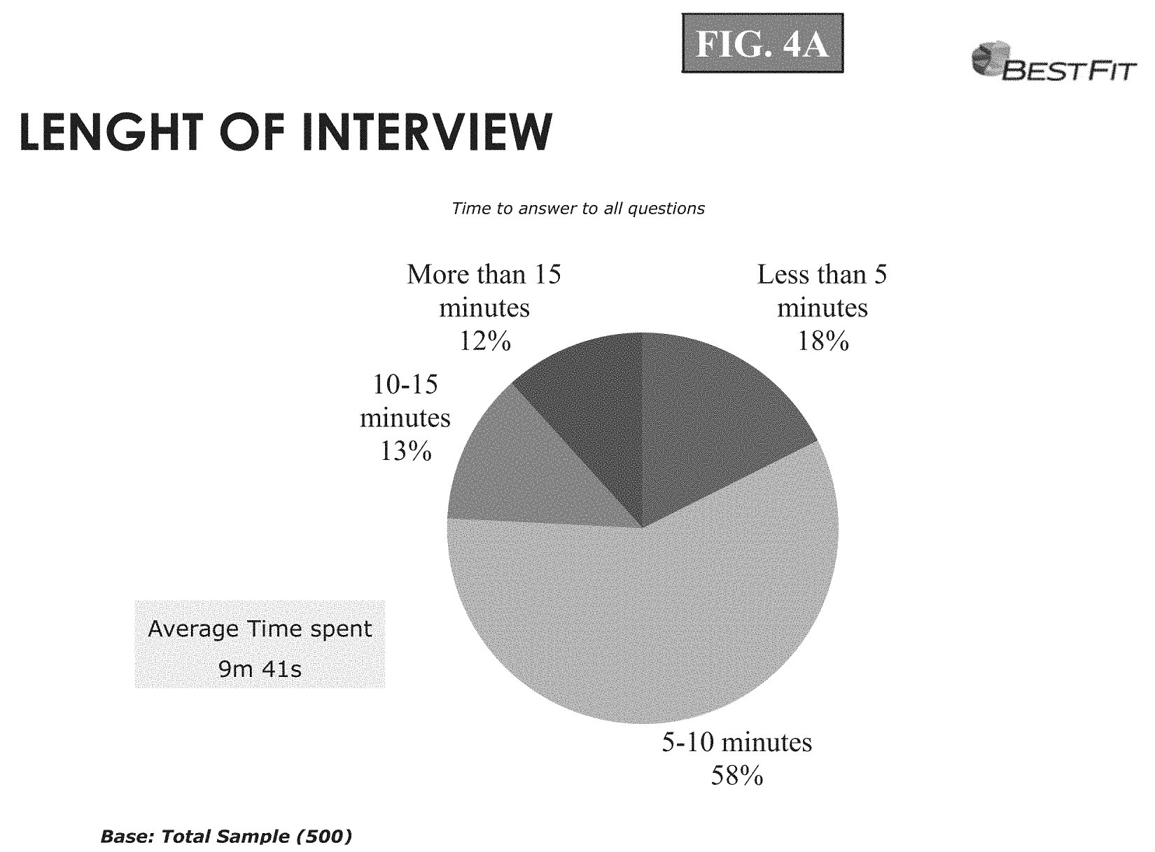

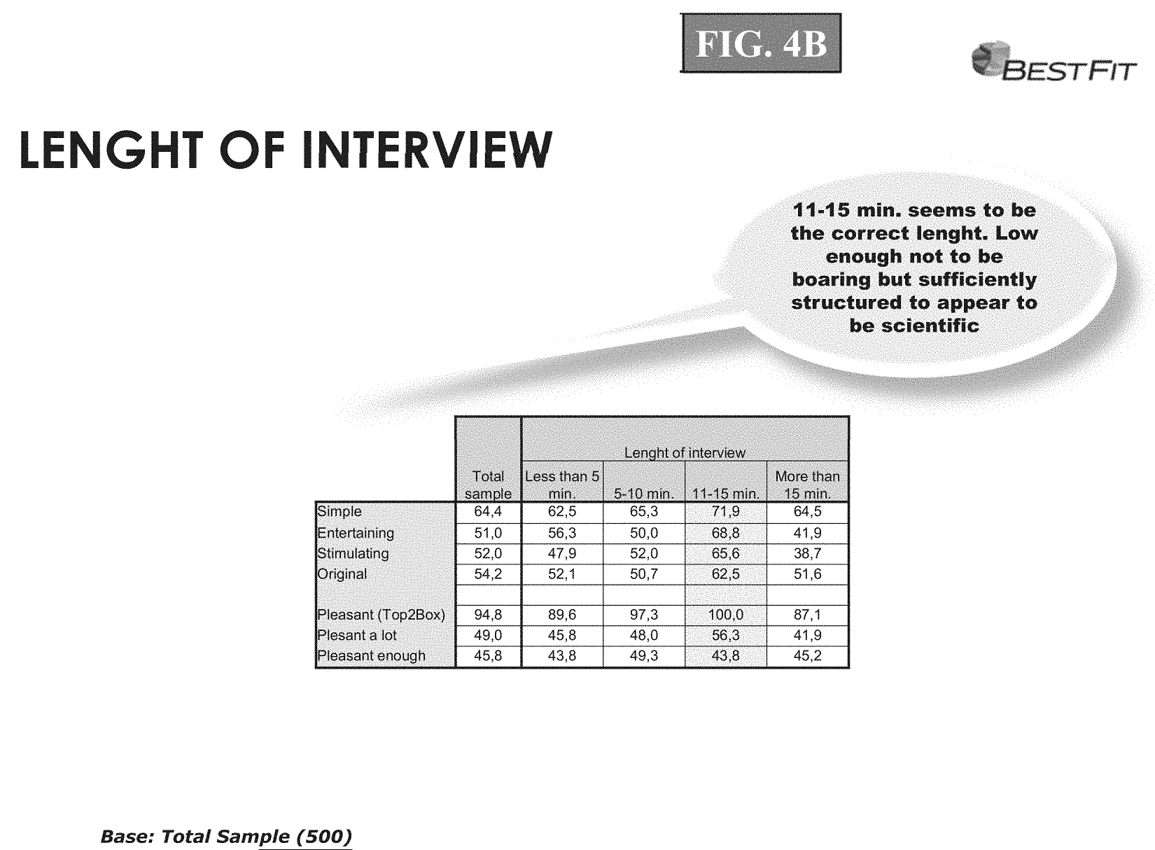

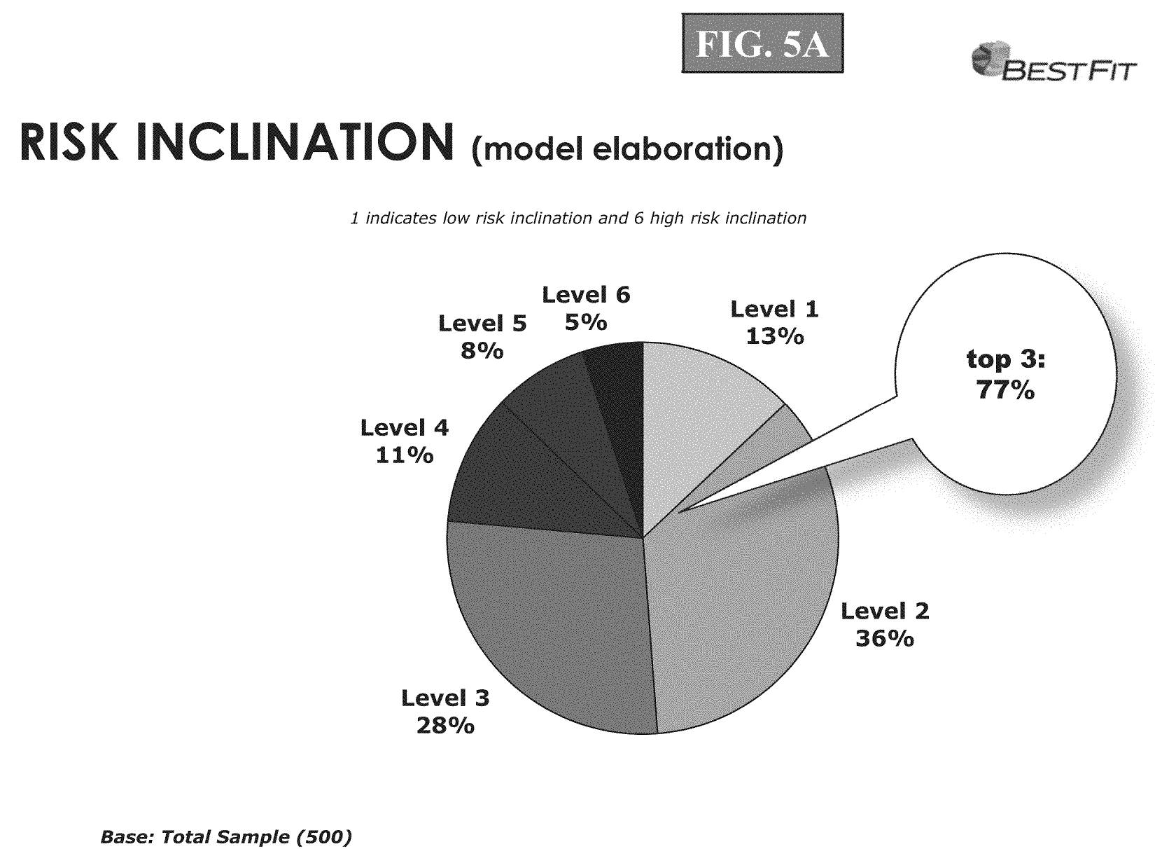

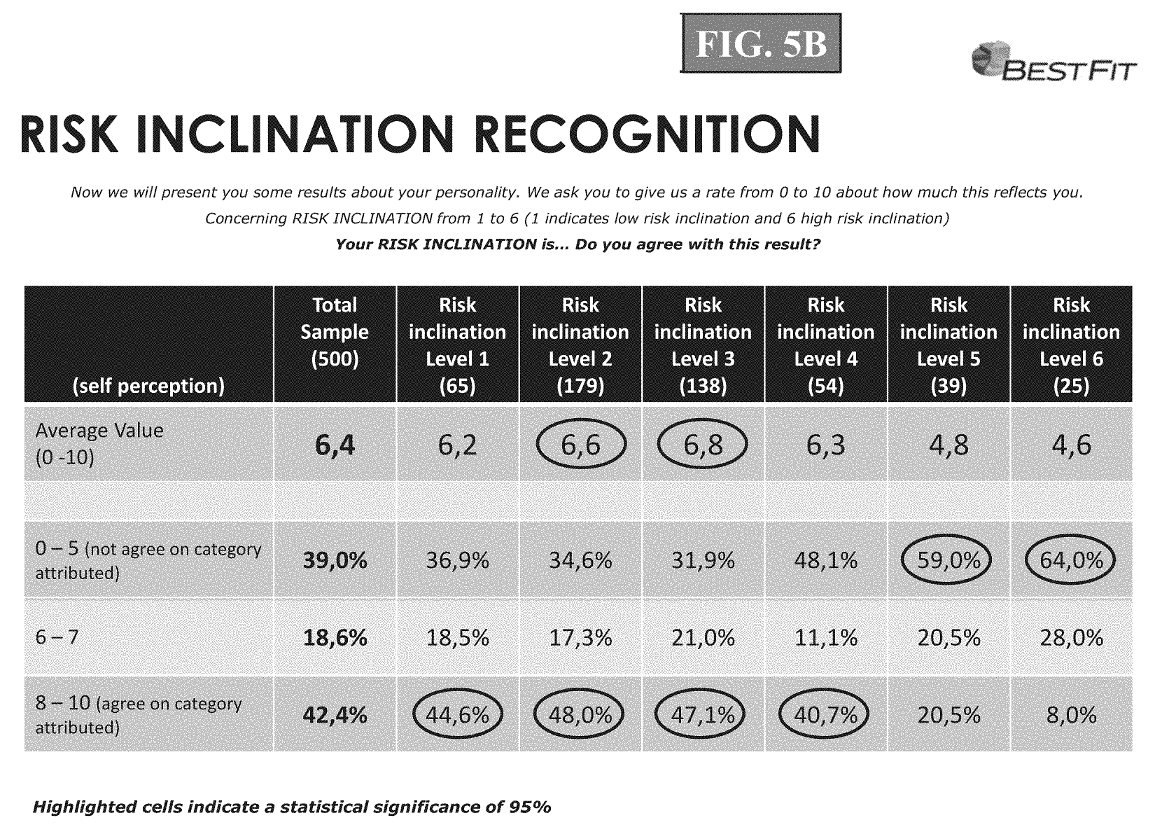

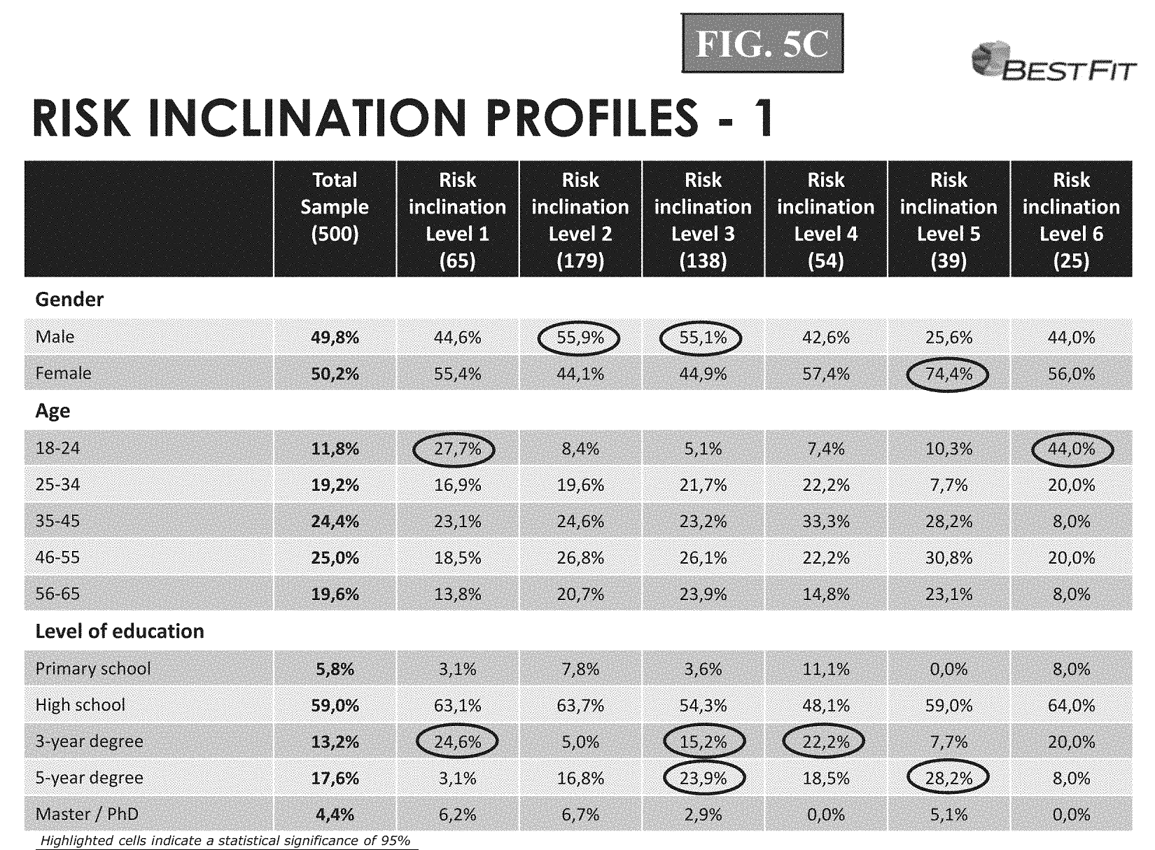

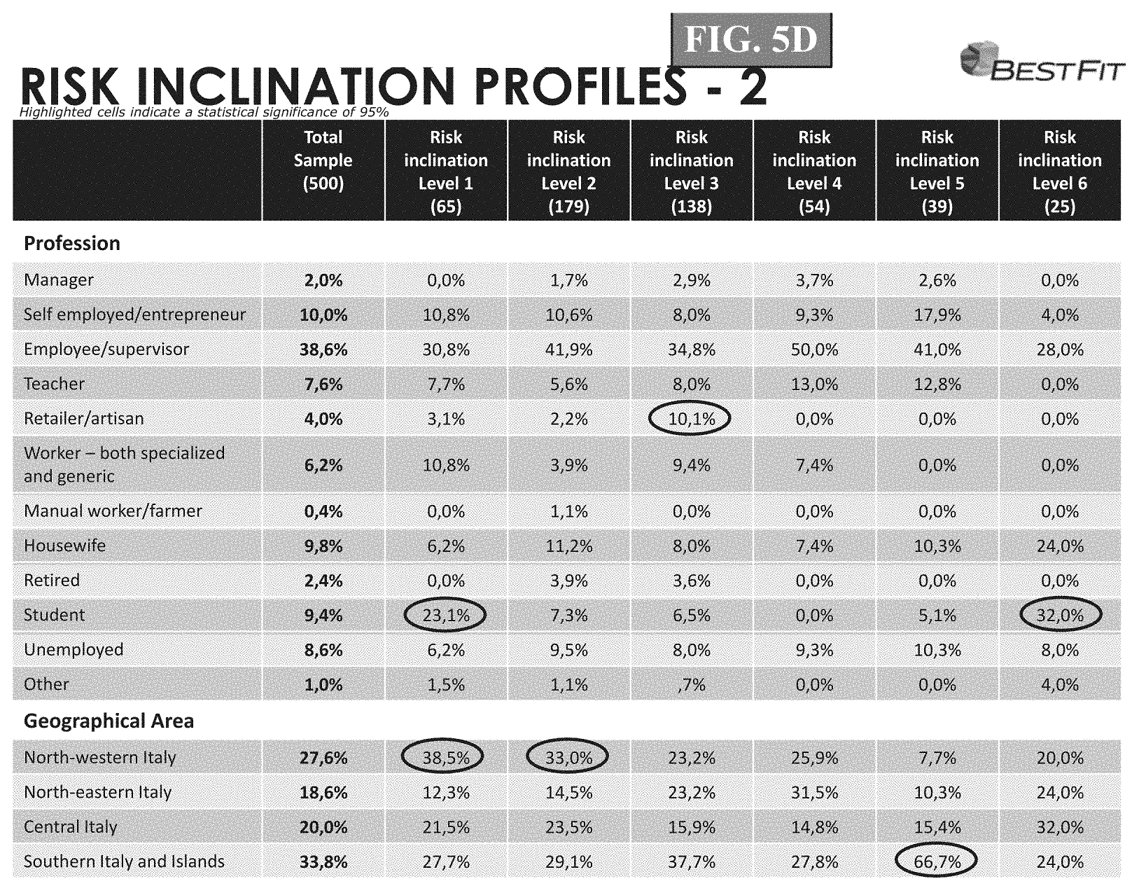

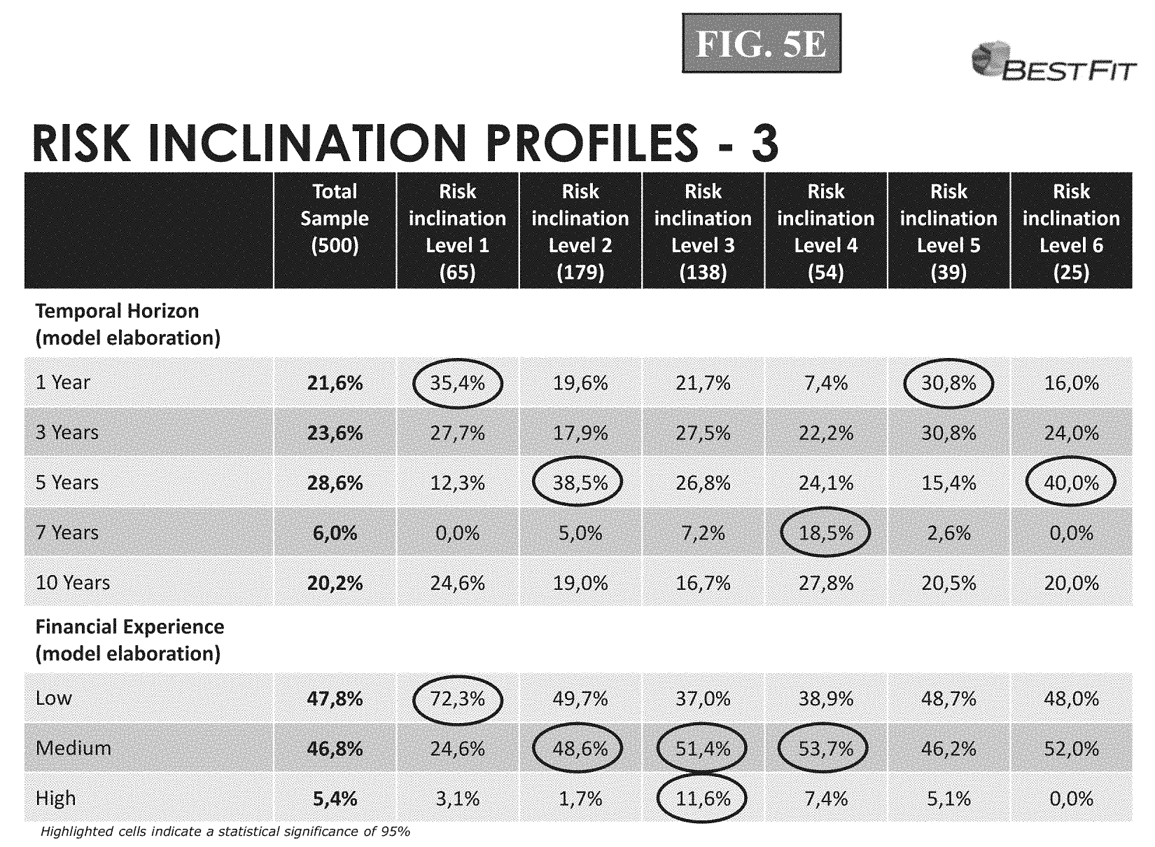

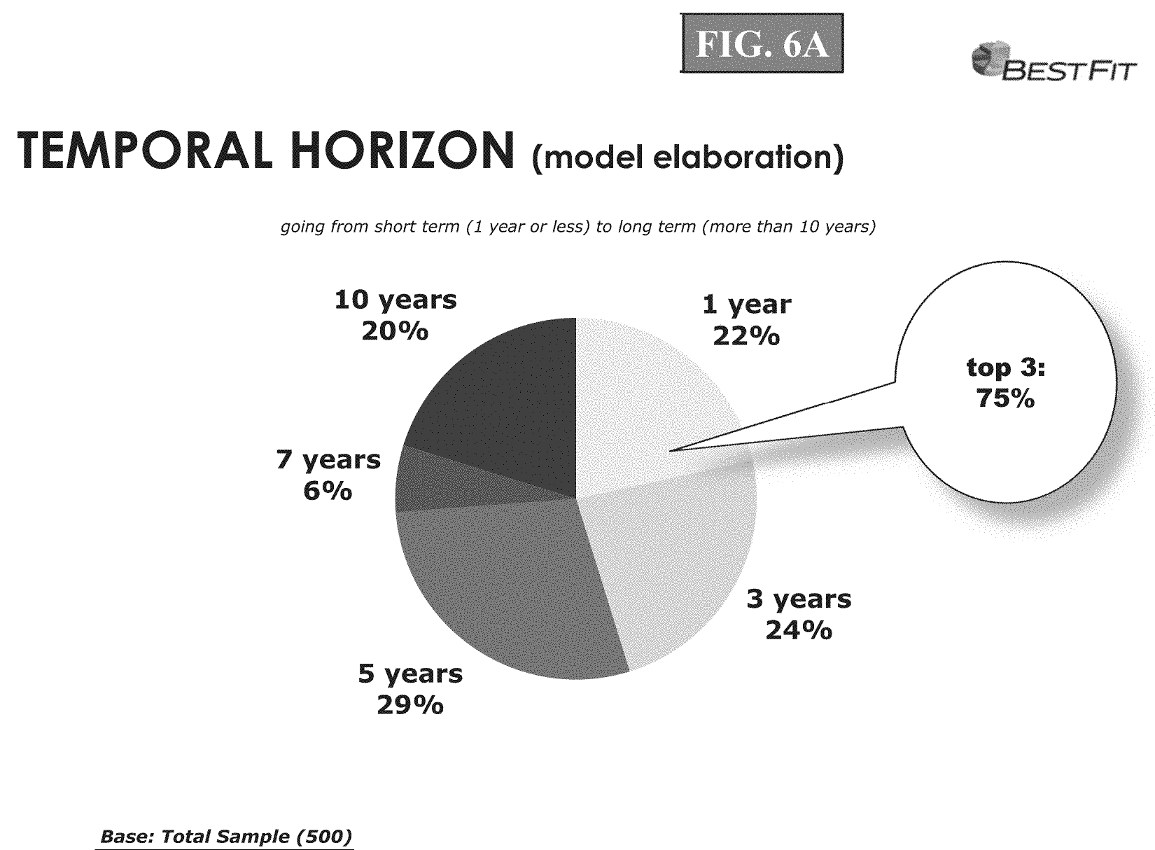

With respect to the drawings, FIG. 2 tabulates the breakdown of the testing sample according to gender, age, level of education, profession, and geographical area (specific to Italy). FIGS. 3A and 3B indicate a very high level of pleasure (or at least comfort) with completion of the questionnaire. Taken in normal context, compared to standard marketing research questionnaires, the results were incredibly high with at least some degree of pleasantness of 95% compared to normal levels of 74%, with Italians being culturally acclimated to not answer polls or questionnaires and usually judge the results as being boring or pushy. There are also factors of “originality”, “challenging” and “entertaining” being expressed about the questionnaire.

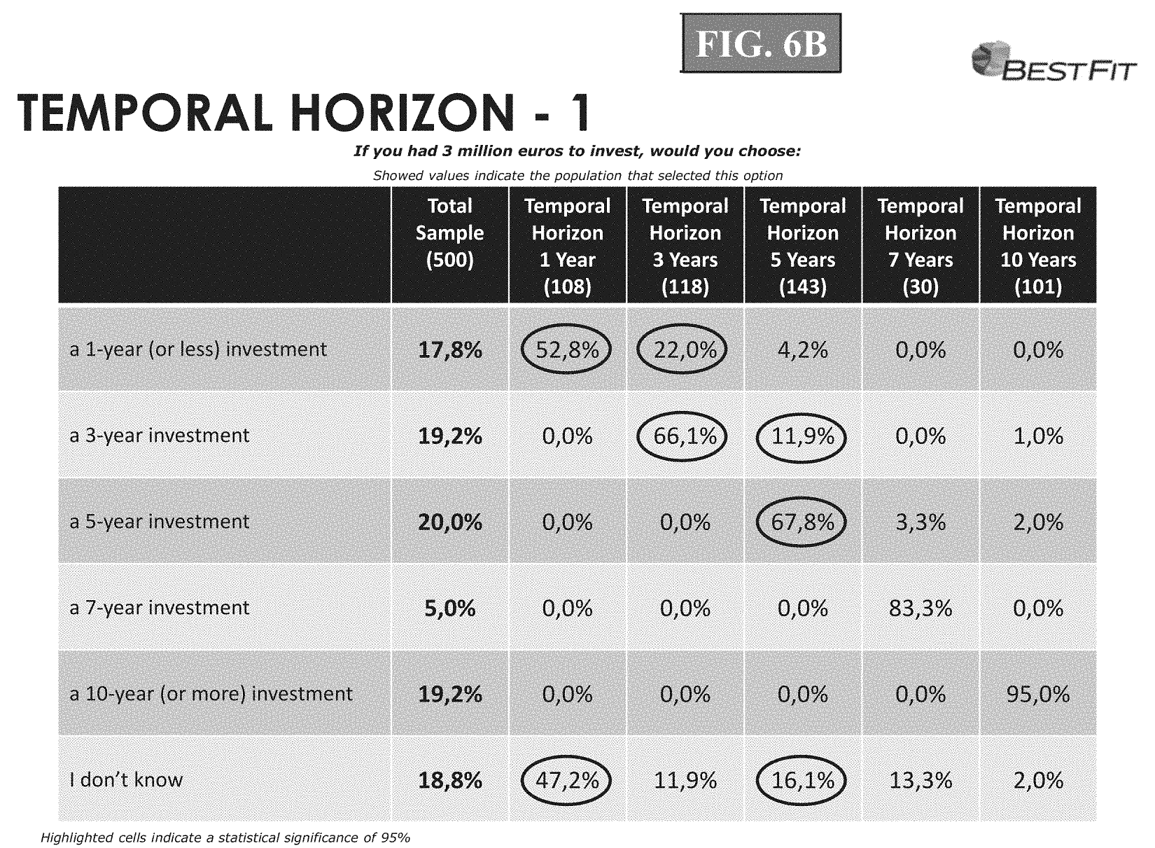

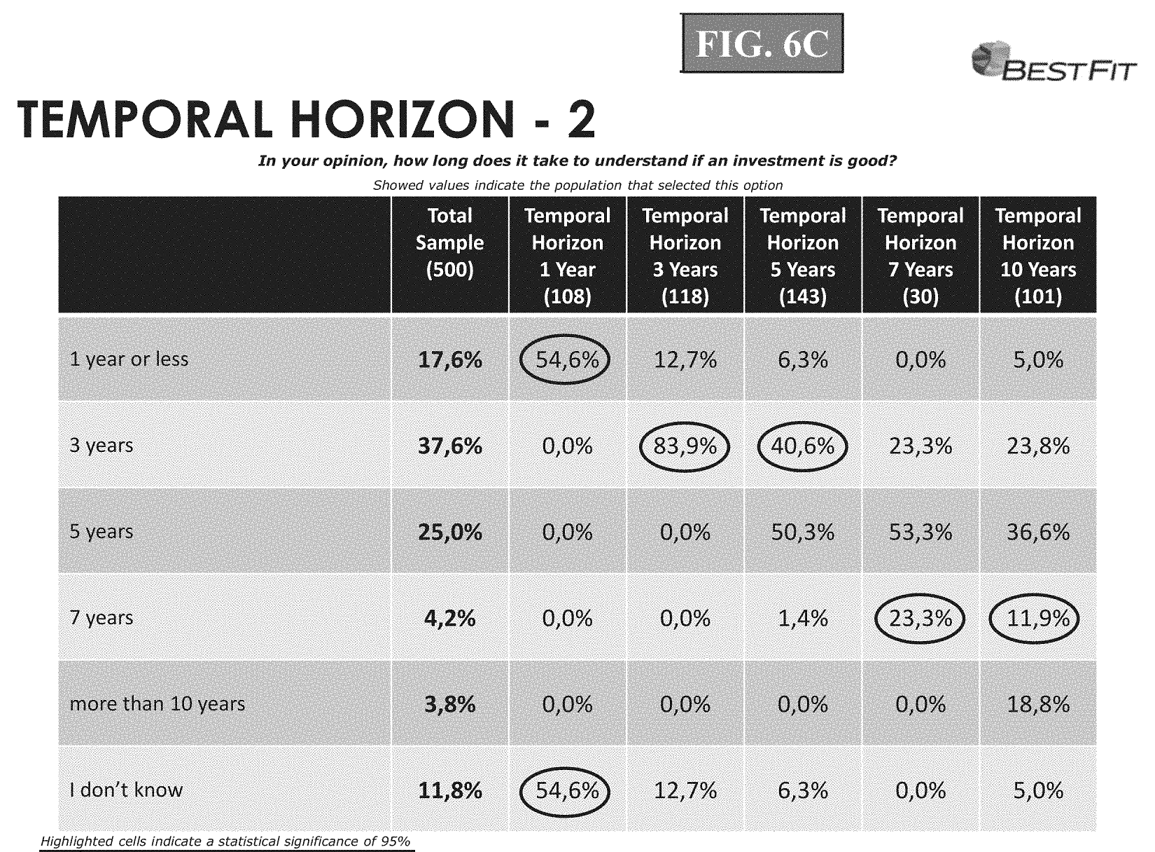

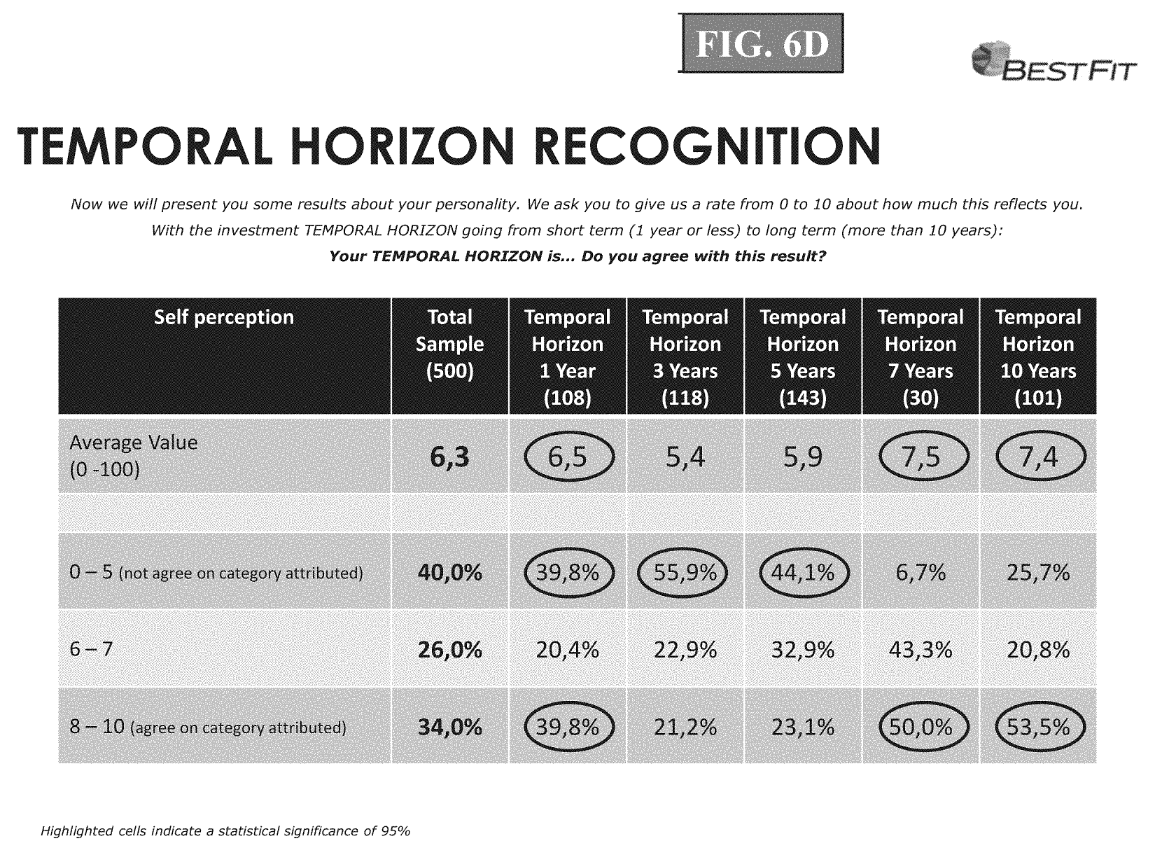

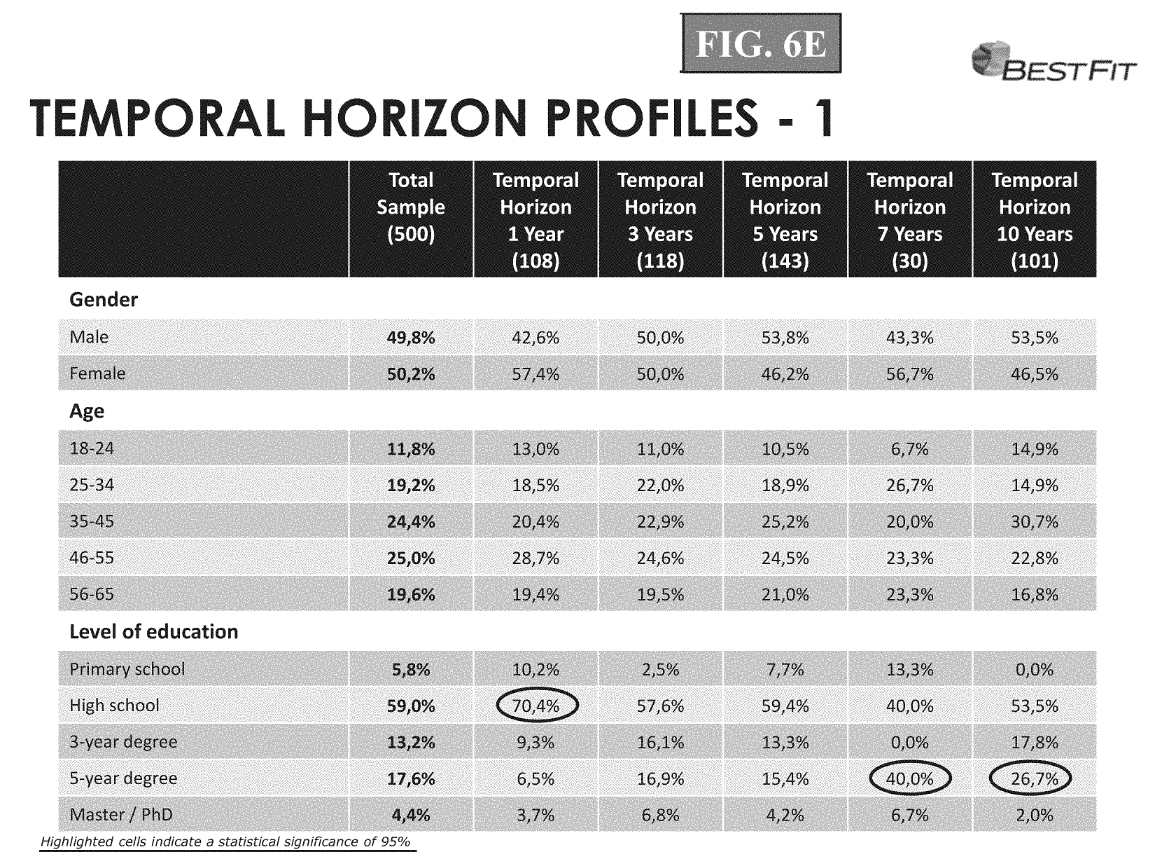

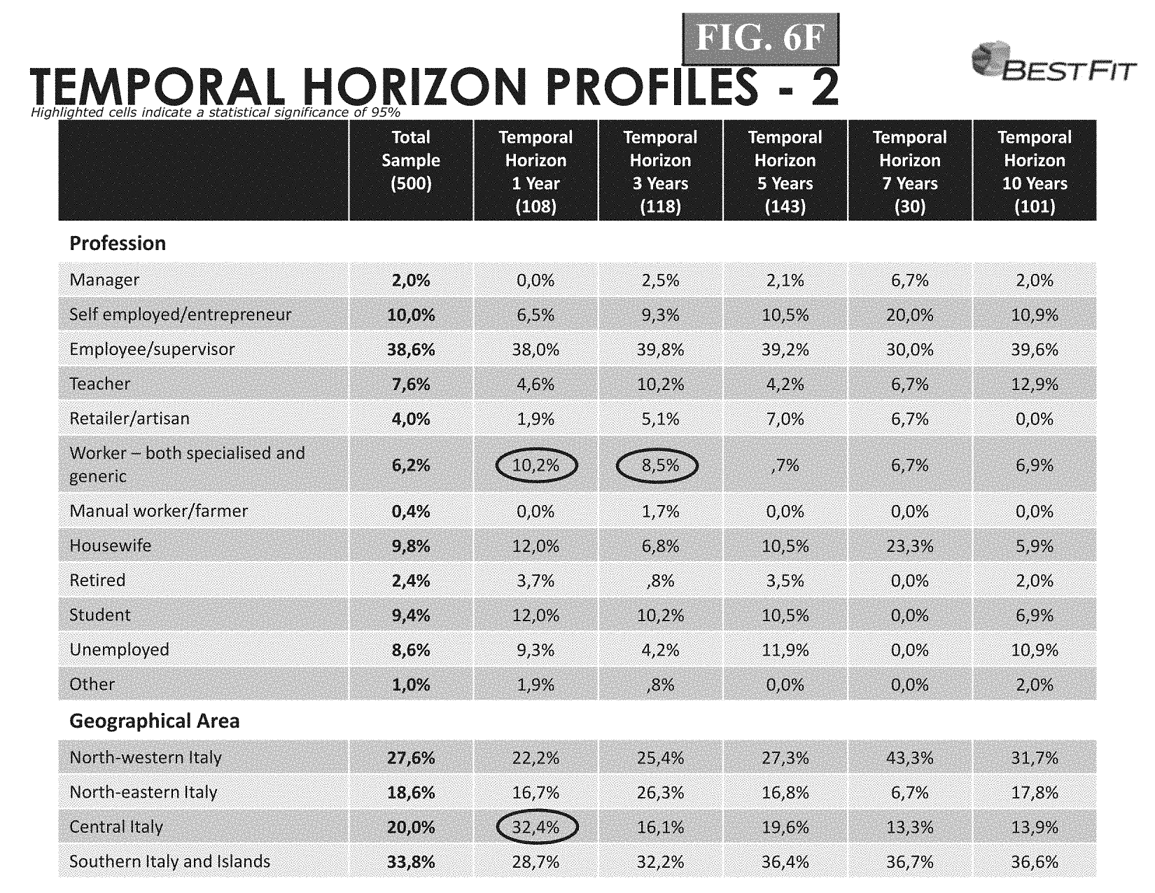

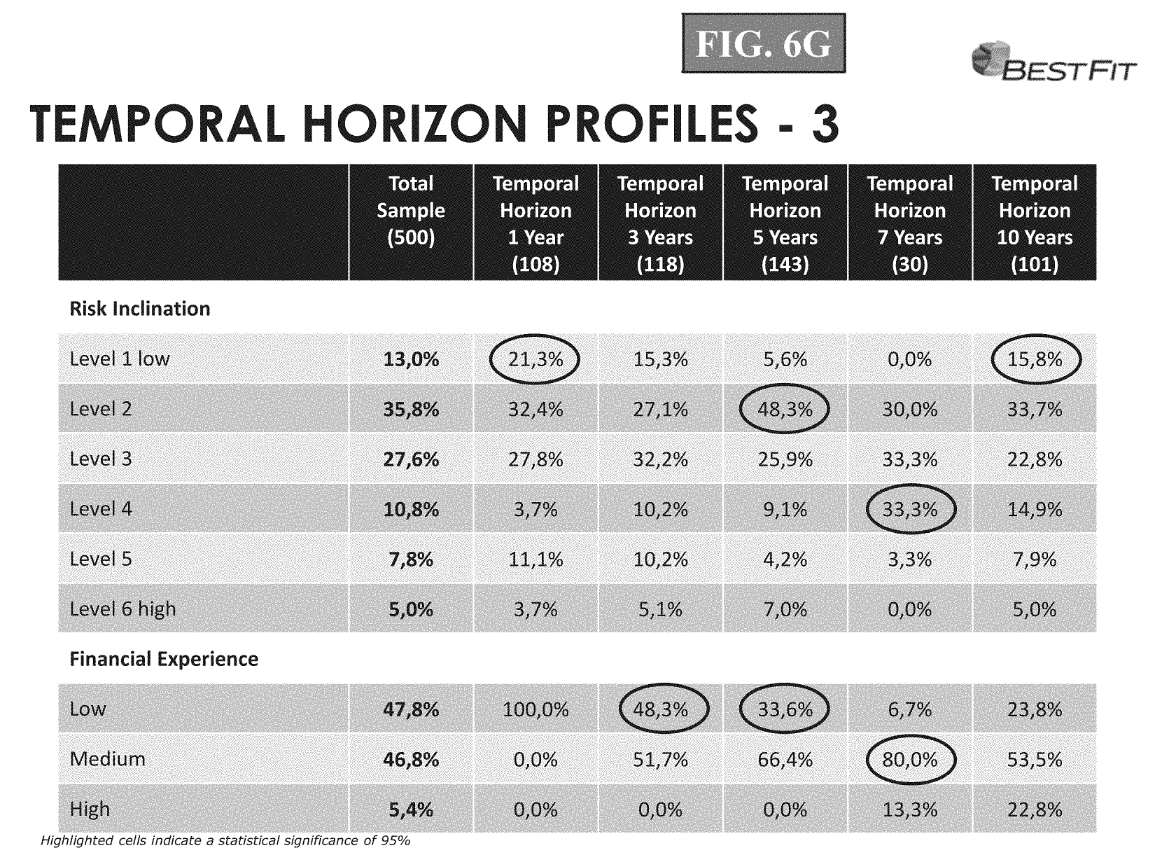

As seen from the tabulated results in FIGS. 4A and 4B, average time for reading and carefully answering the questionnaire was a non-onerous time under 10 minutes.

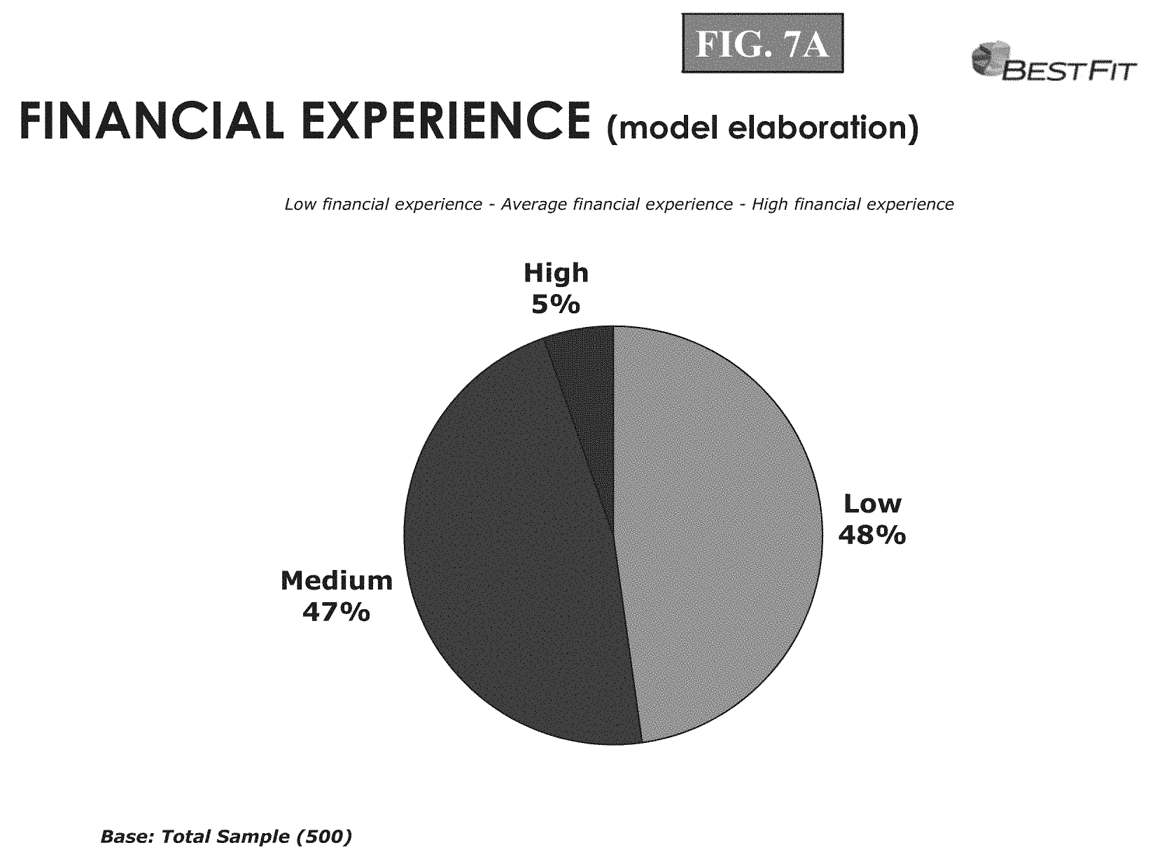

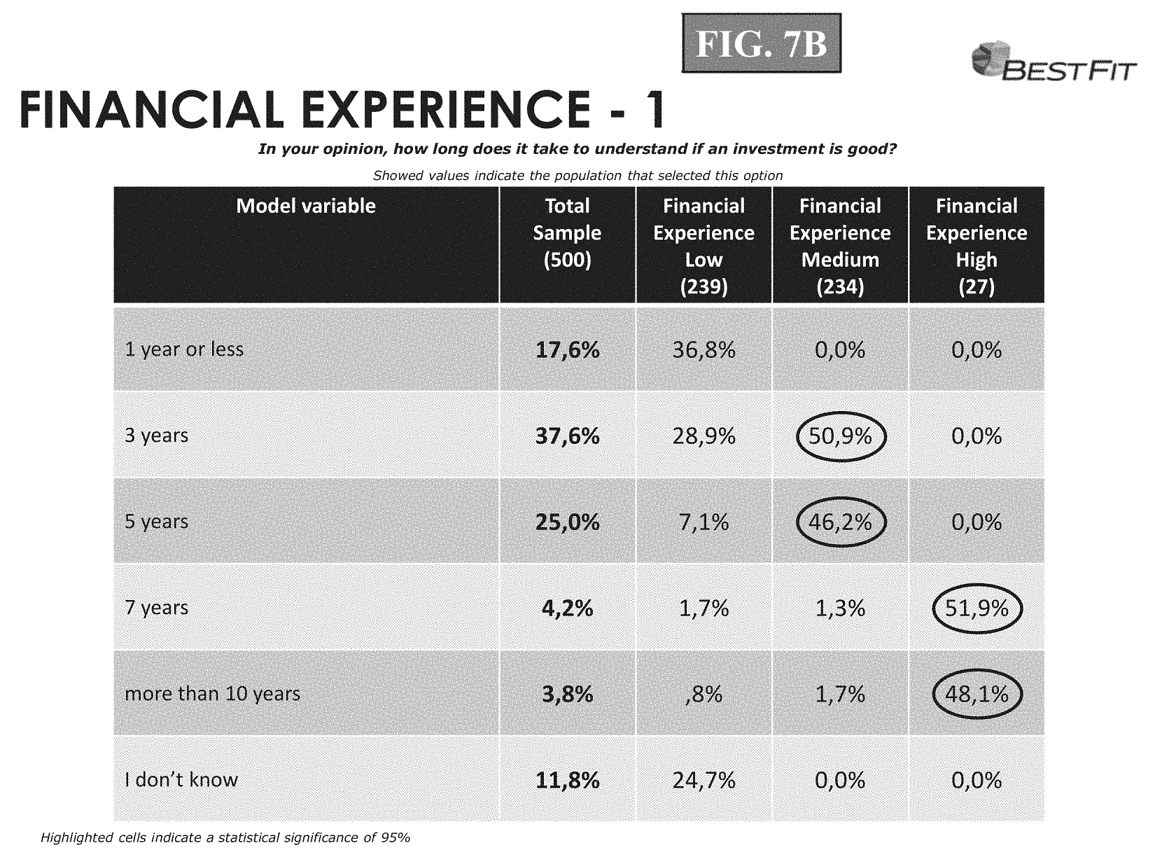

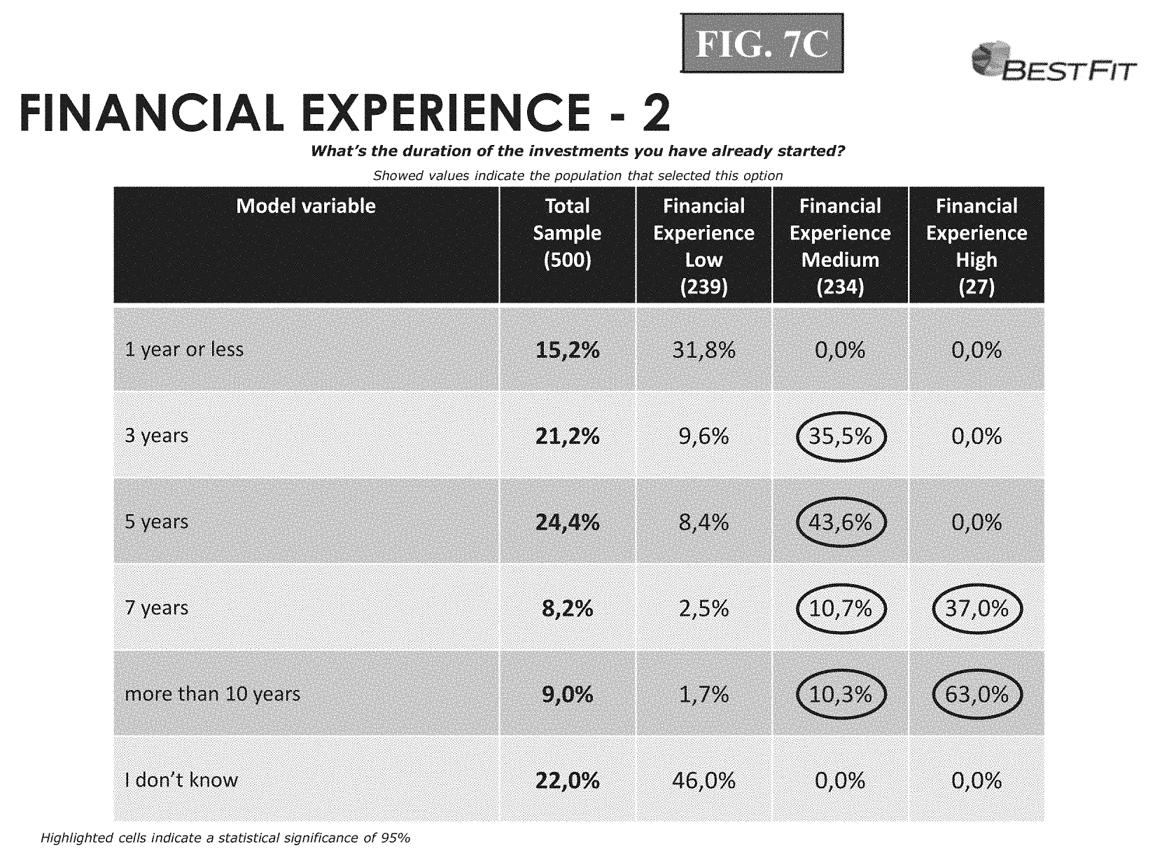

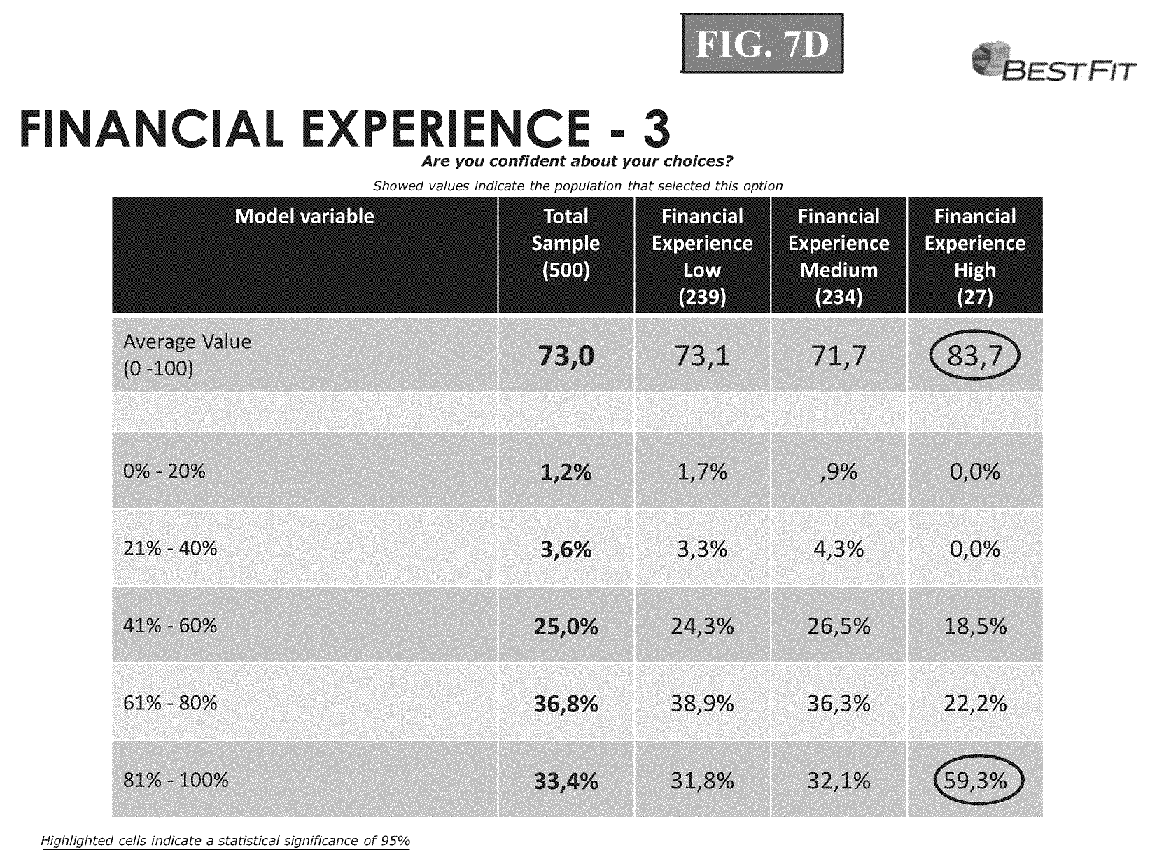

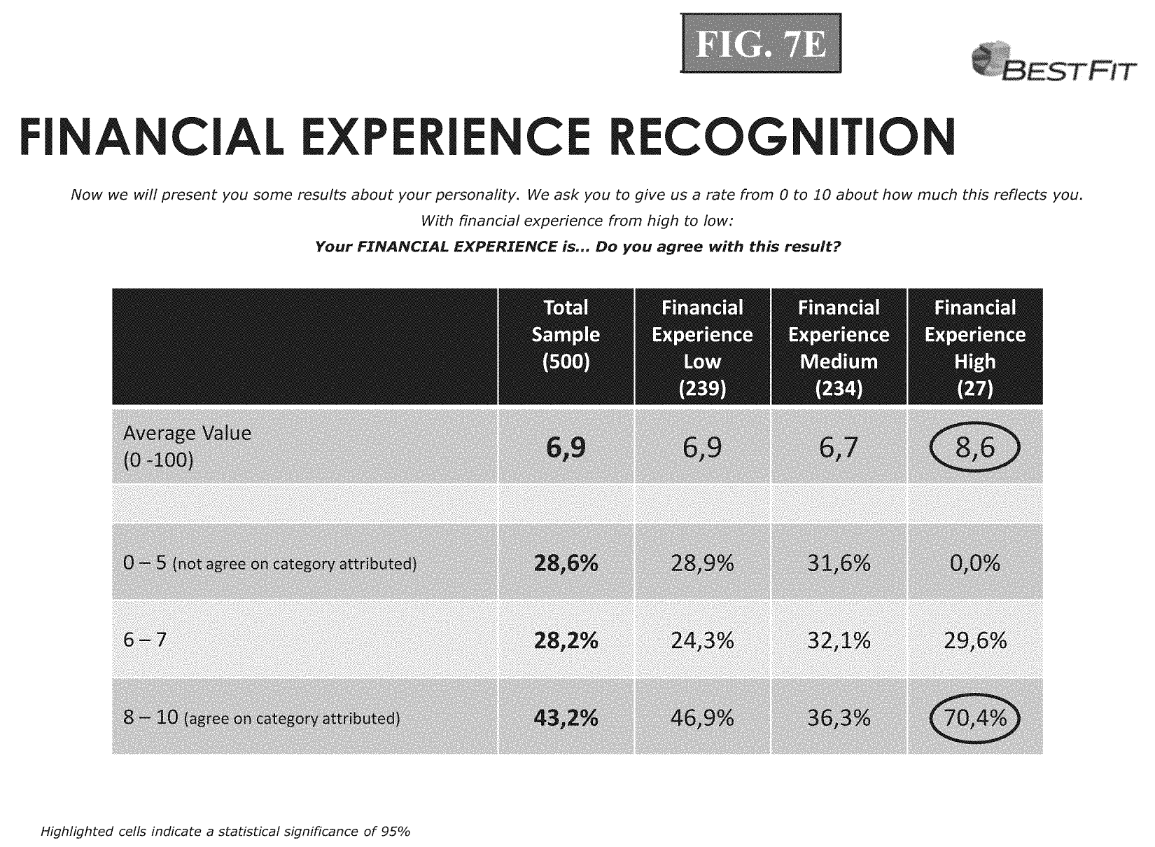

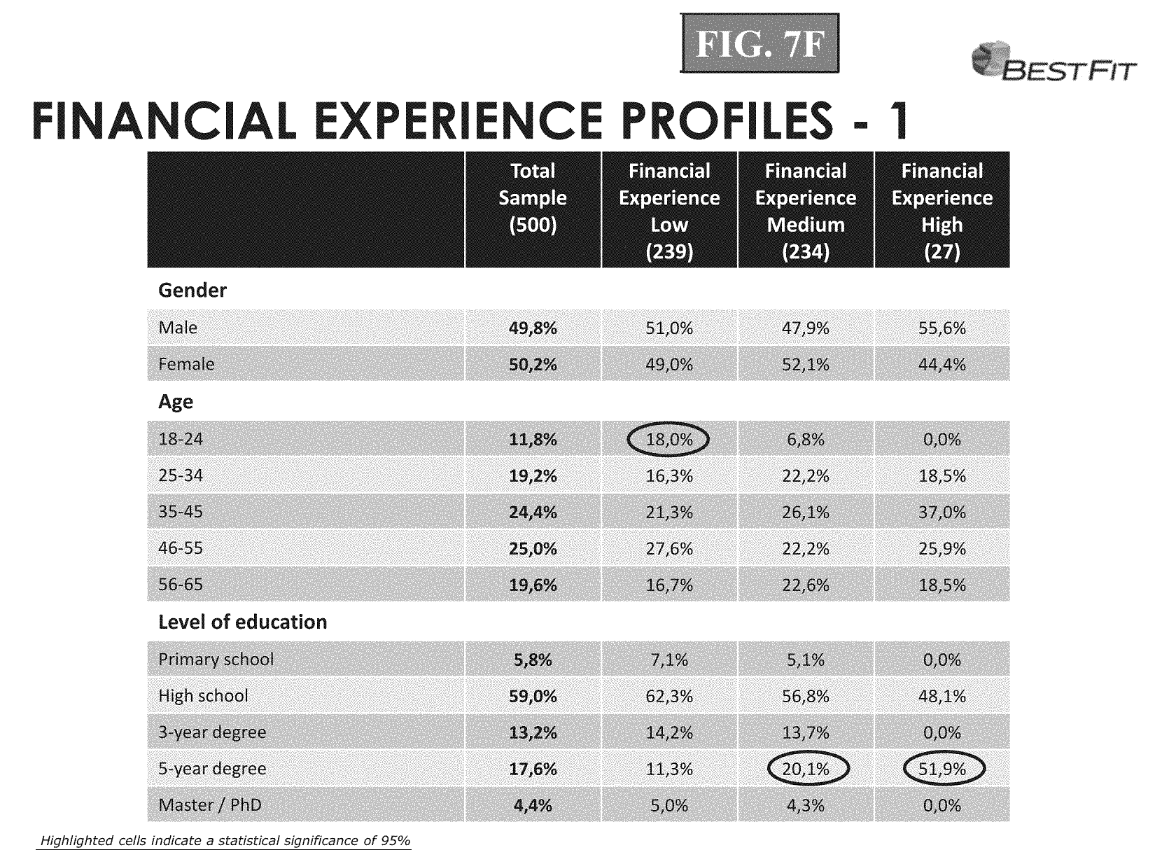

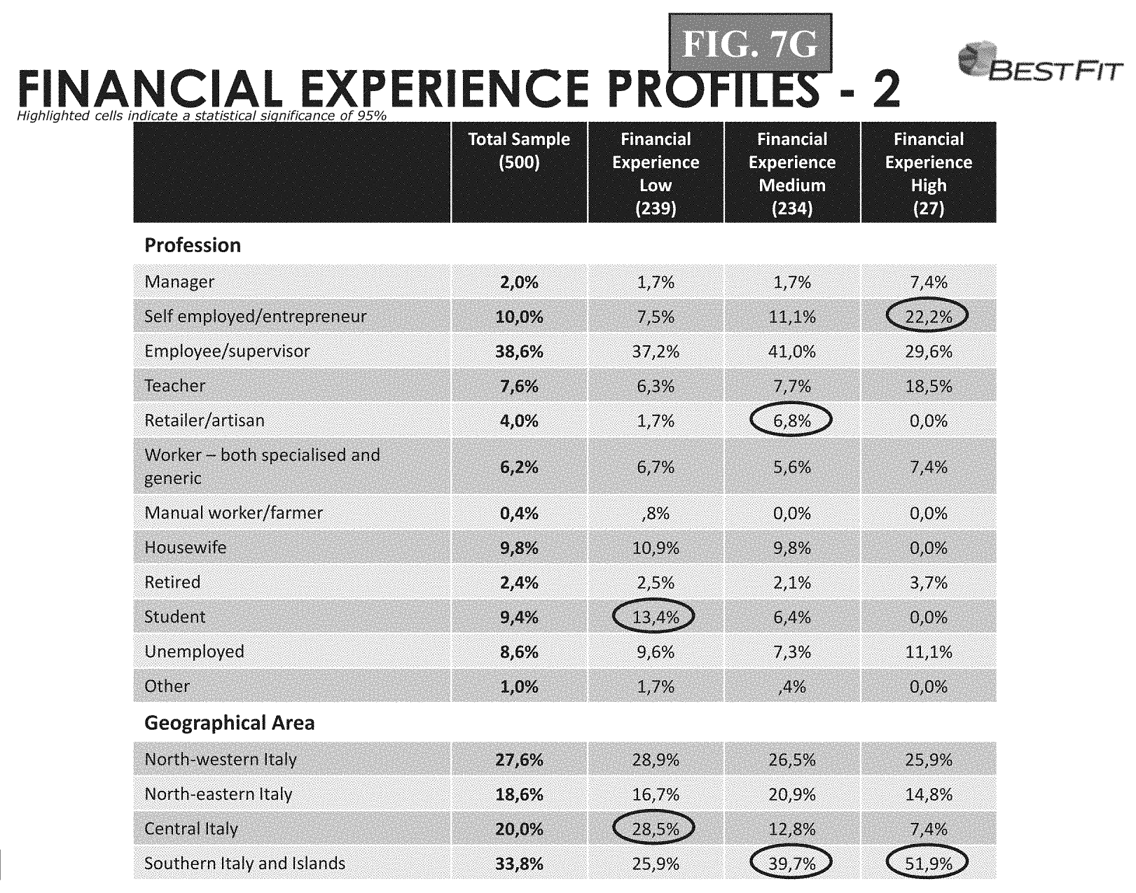

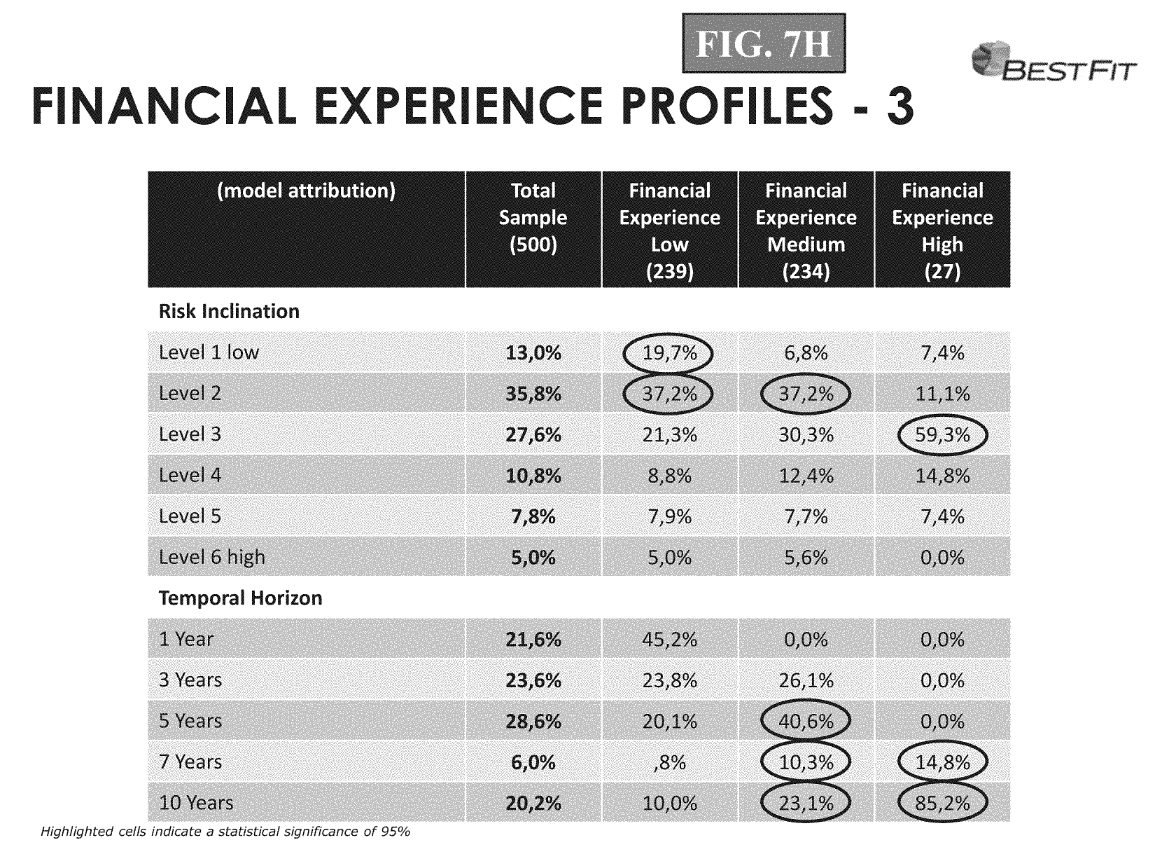

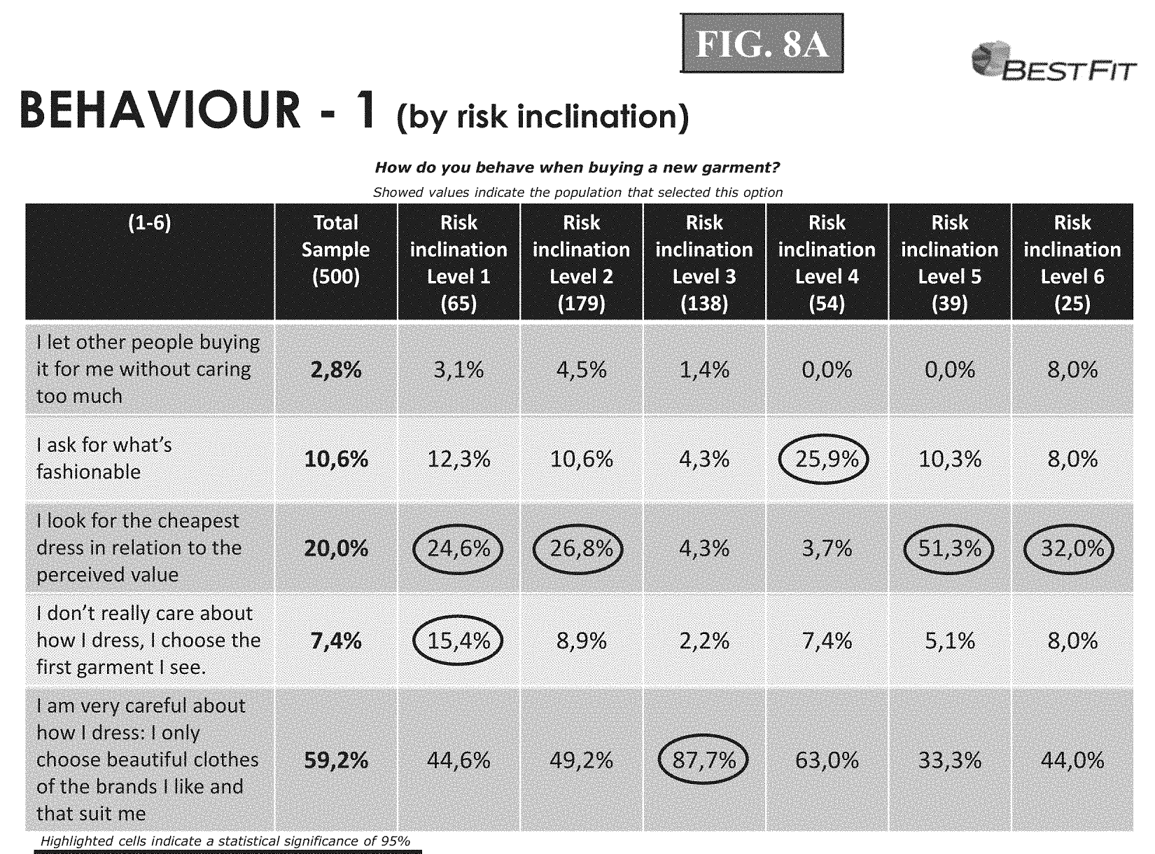

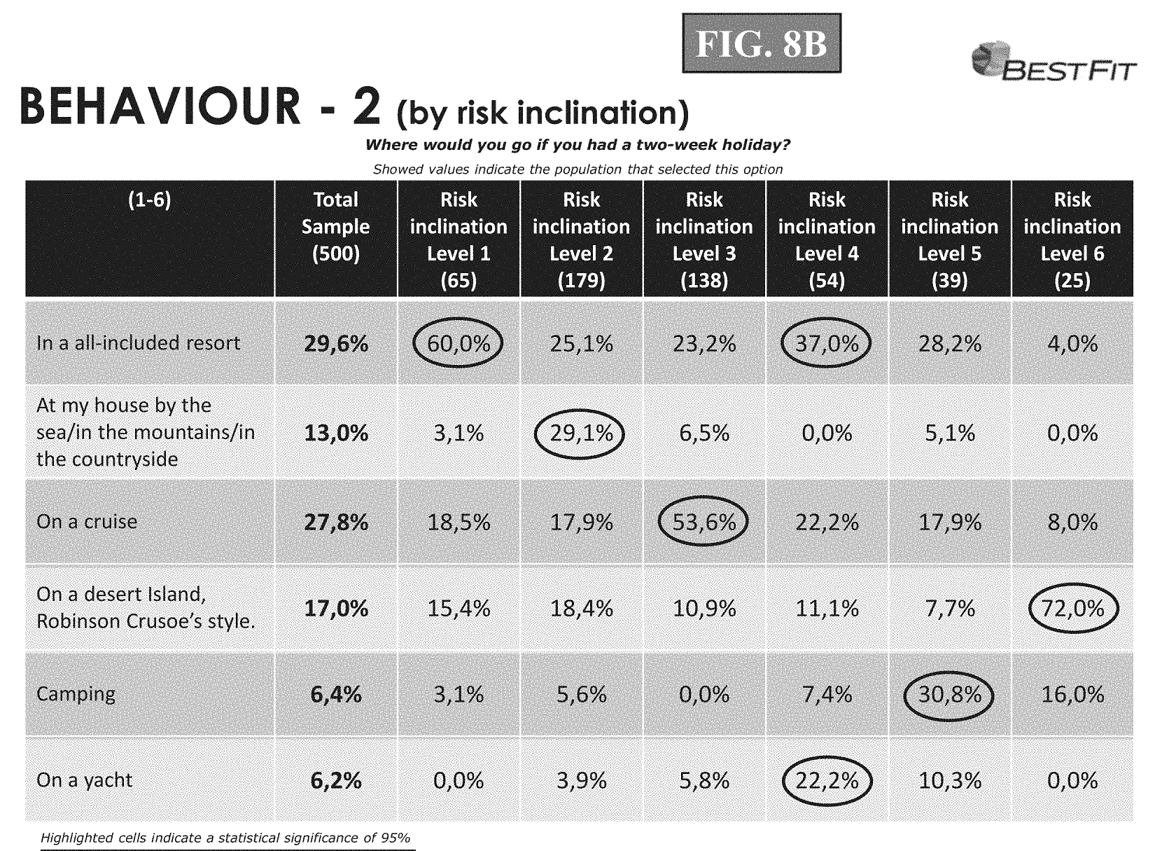

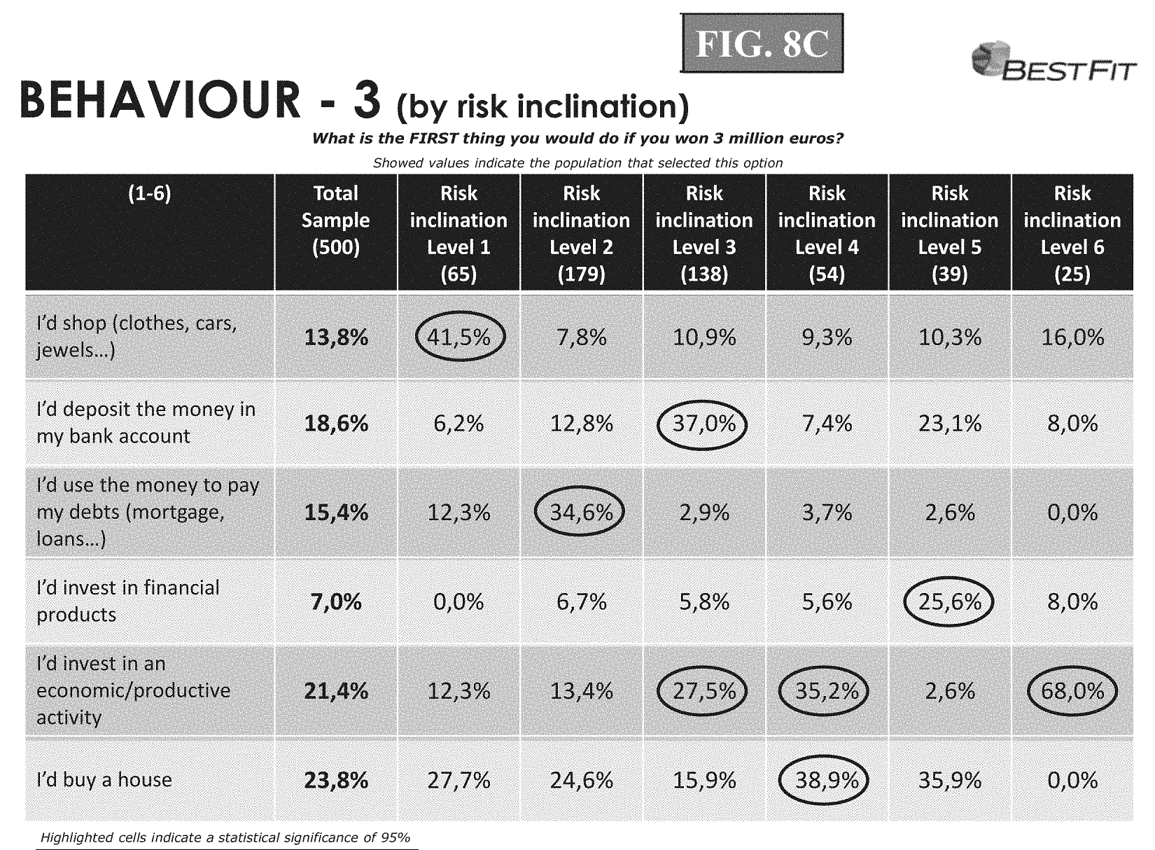

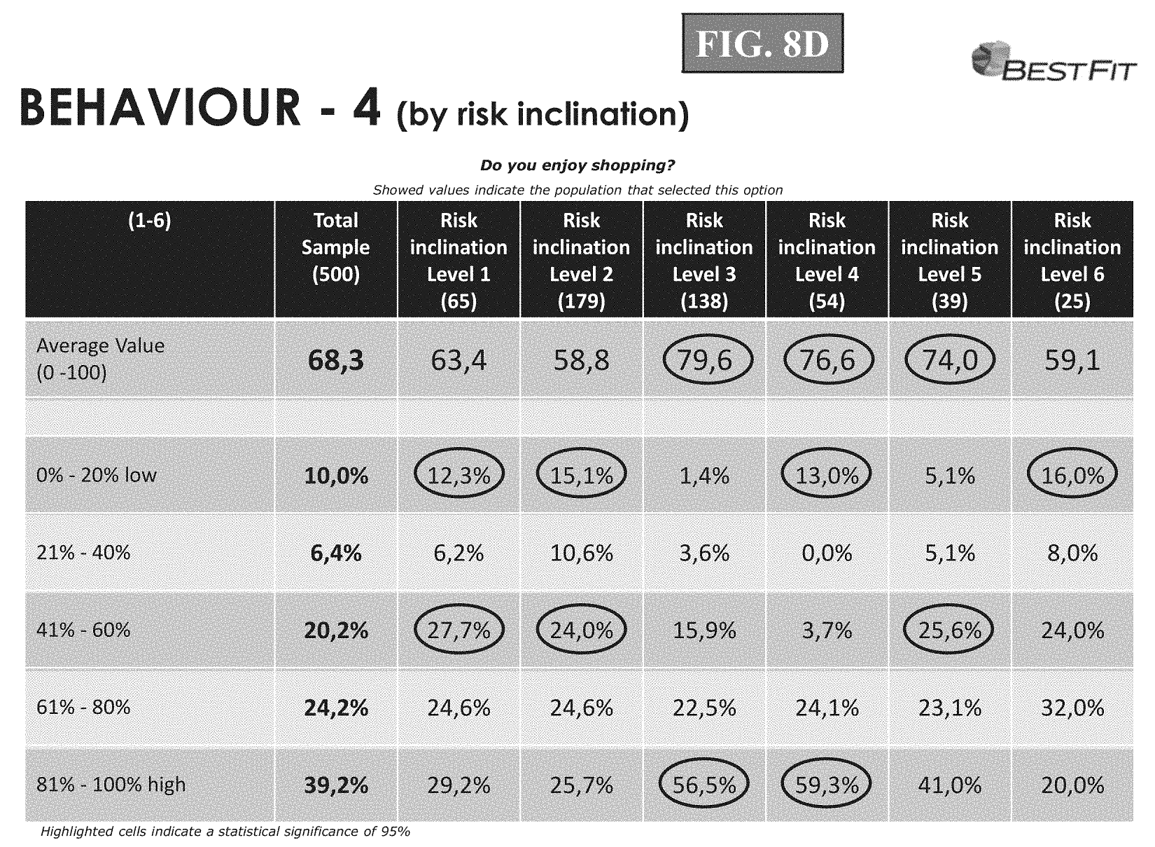

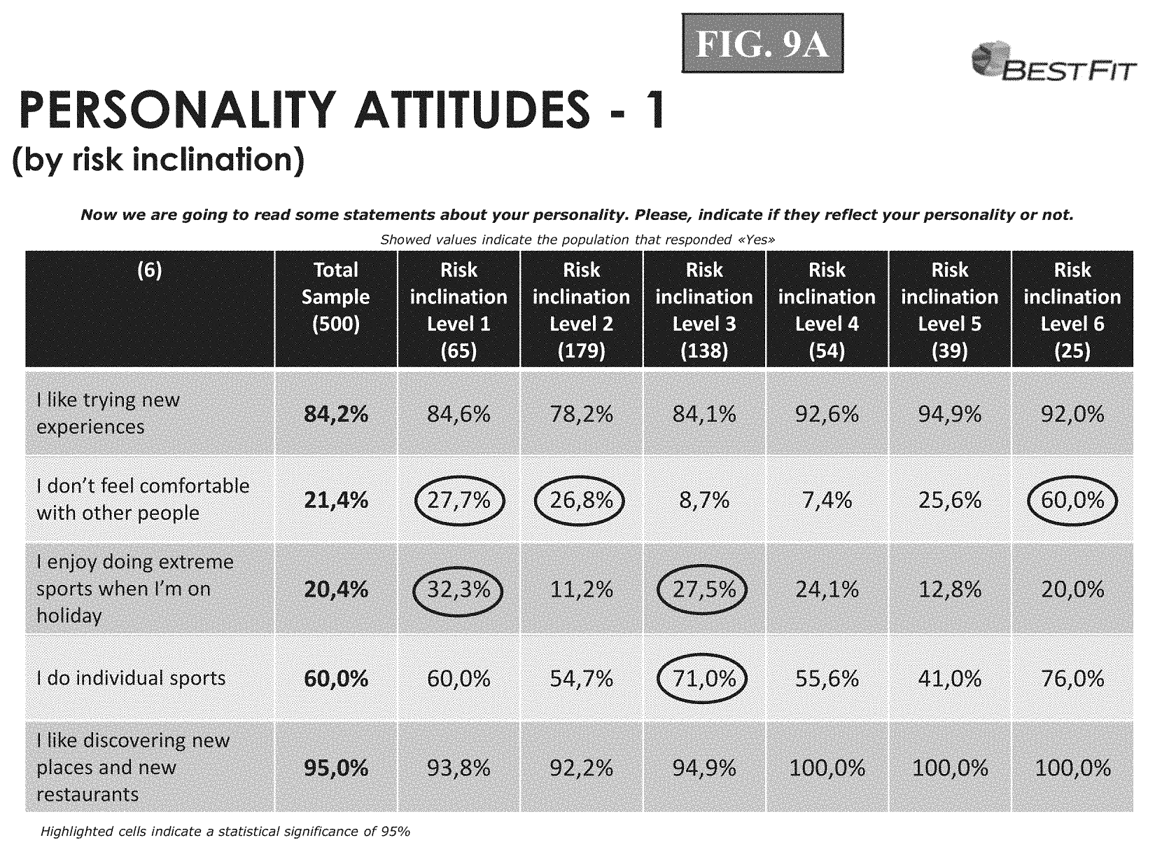

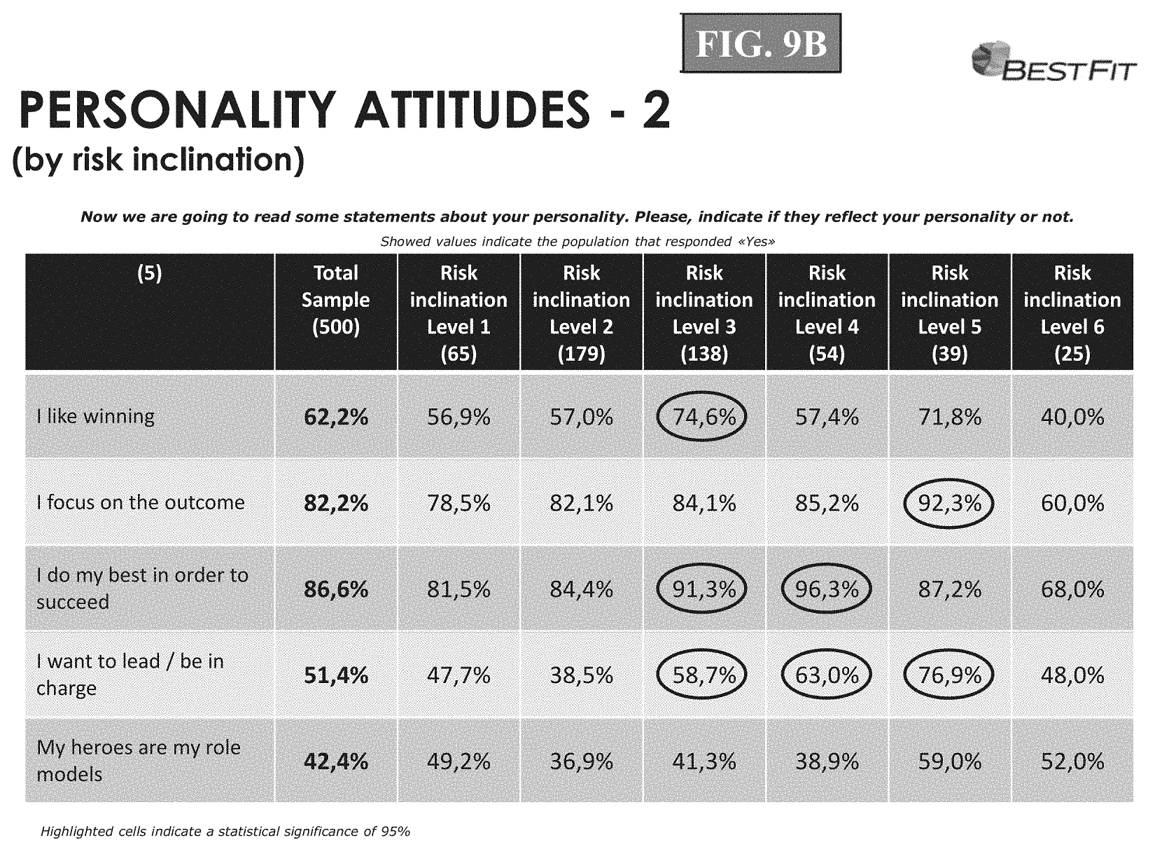

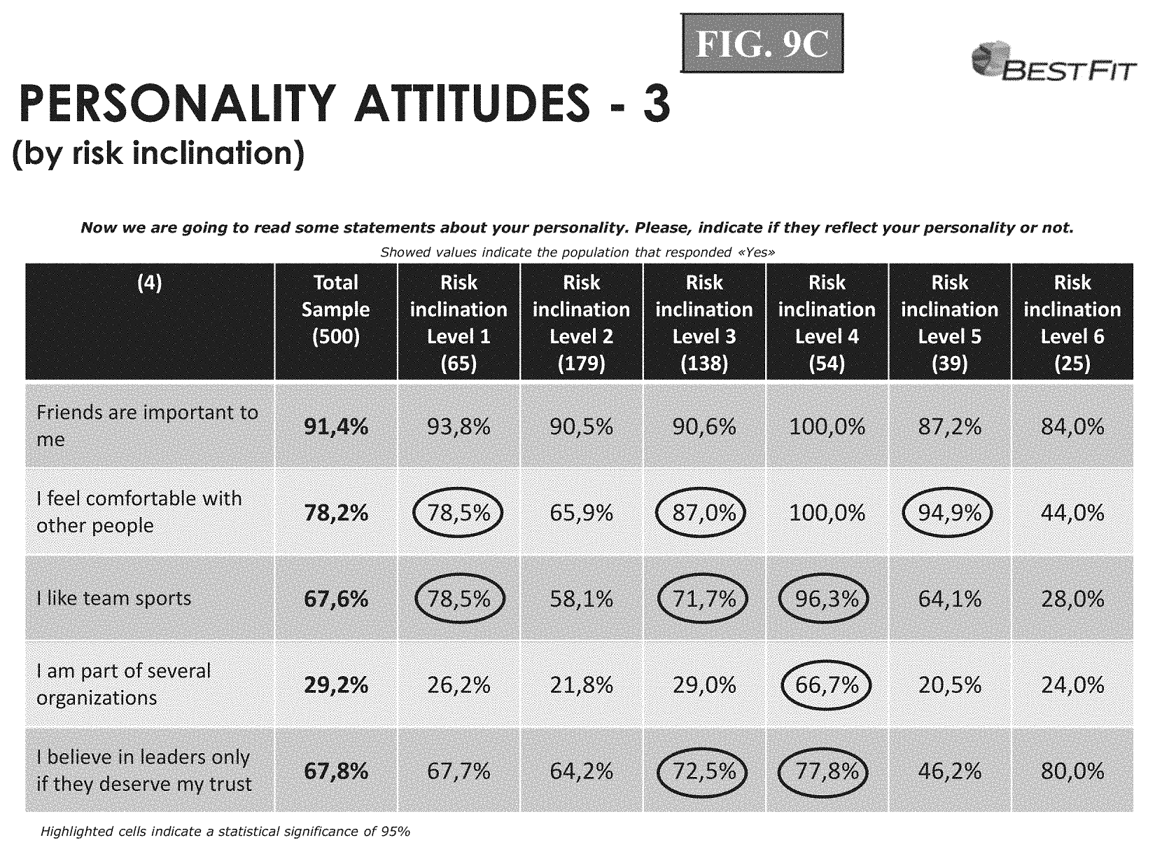

The tabulated results in FIGS. 5A-9F exhibit risk and behavioral profiling results for Risk Inclination (FIGS. 5A-E), Temporal Horizon (or future outlook) in FIGS. 6A-G, Financial Experience is tabulated in FIGS. 7A-H, general Behavior characteristics are tabulated in FIGS. 8A-D and Personality Attitudes are tabulated in FIGS. 9A-F. Users with low financial knowledge are tabulated with only 5% being considered and expert. With respect to risk factors or “fear” as much as 77% of respondents emerge with a level 3 risk and with limited temporal horizons as much as 75% within 5 years of ten in terms of the time horizon.

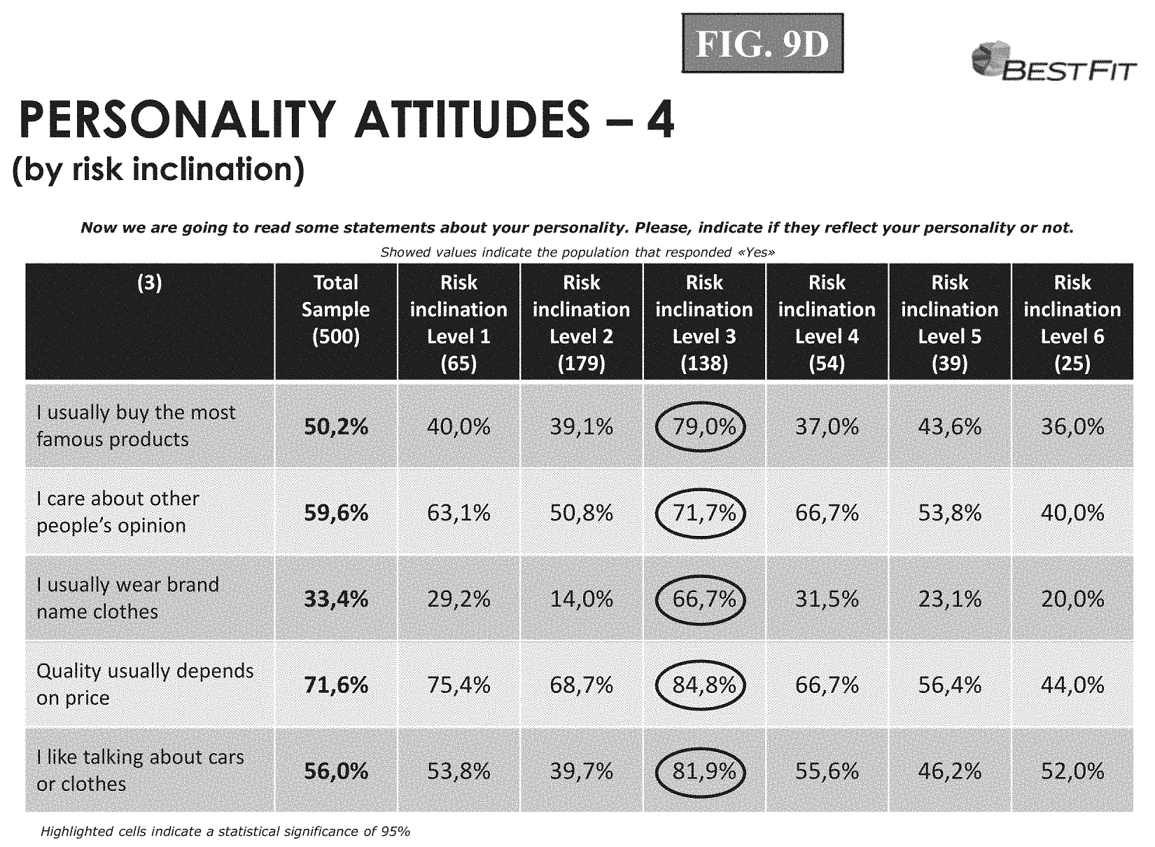

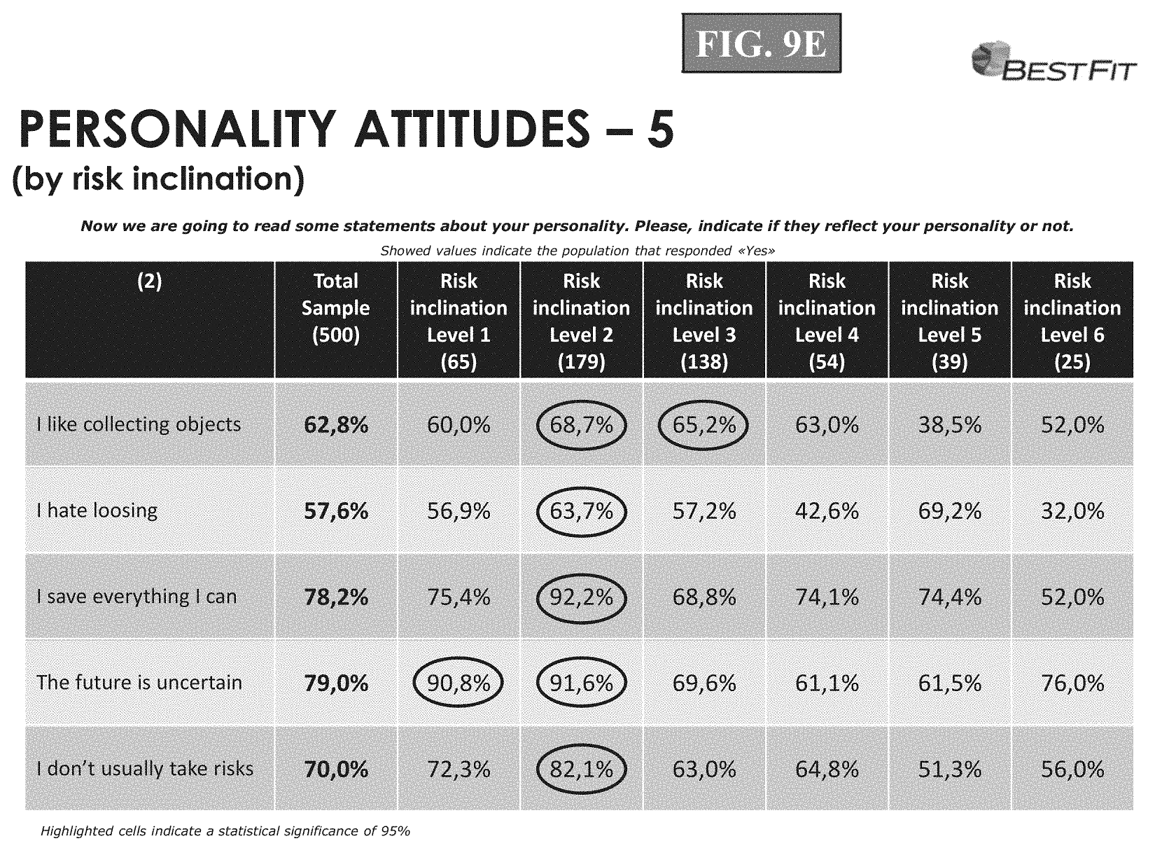

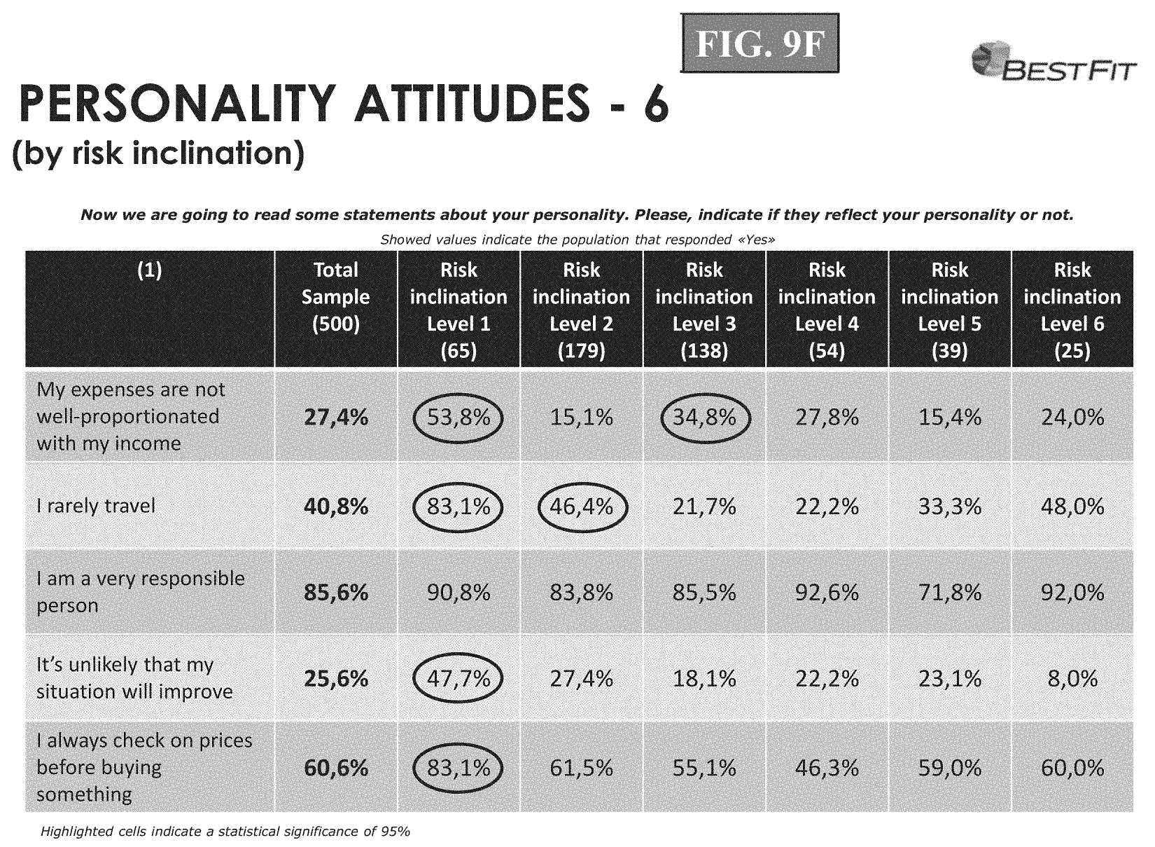

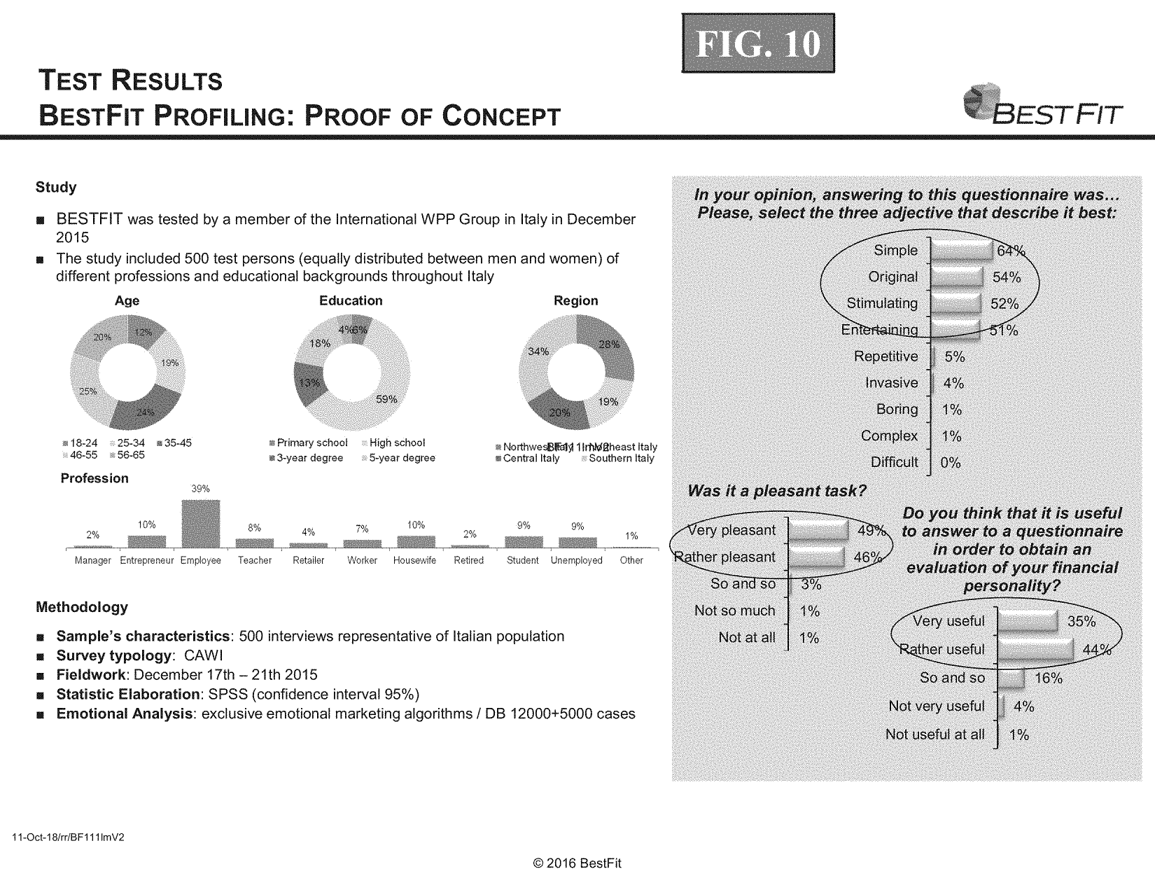

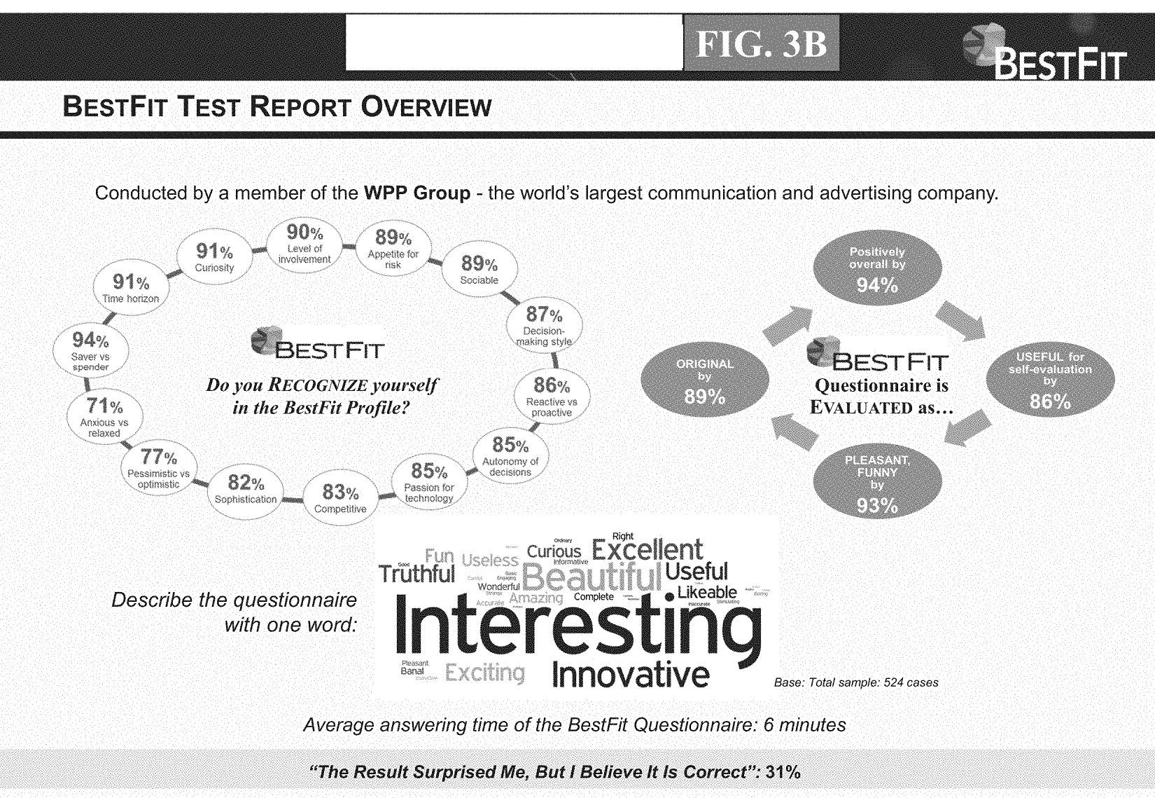

FIGS. 10 and 11 summarize all of the results with obtained results within the profiled percentage parameters in excess of 70%.

It is understood that the above is illustrative of the present invention and that changes in questions, formulations, analysis, applications other than for financial matters and the like may be made without departing from the scope of the invention as defined in the following claims.

What is claimed is:

1. A method for establishing a personalized investment portfolio comprising the steps of:
a) starting from a client's investor behavior and experience establishing a client profile based on questions regarding the client's behavior of daily life and investment approach and experience to provide a behavioral profile;
b) constructing a computer program model to determine optimal asset class allocation for each client profile covering a wide range of assets, including real estate, insurance, arts and traditional financial asset classes as a holistic asset allocation; and
c) establishing a model of a personalized ranking of financial investment products for a client investor, based on product characteristics and investor profile with a best fit investment program.

2. The method of claim wherein, information is collected from the client investor via a questionnaire and an algorithm converts the collected information into a synthetic value, which represents the profile of the client with a multidimensional profile approach wherein output of the algorithm is, an array of values, with multiple different parameters comprising the following values and combinations thereof:
1. Risk Propensity (1 low, 5 high)
2. Time Horizon (years)
3. Sophistication [symbol]
11. Stress Management
12. Optimism
13. Sociability
14. Proactivity
15. Competitiveness
16. Engagement
17. Decision Making Style
18. Decision Autonomy
19. Social Network presence
20. KI Fashion
21. KI Shopping
22. KI Sports
23. KI International
24. KI Collections
25. Tech Friendliness
26. Curiosity
27. Focus on savings,
wherein the algorithm assign different values to each of these parameters and wherein each answer to the questionnaire may affect several of the parameters with calculation of the values being effected with a scoring matrix, with rows corresponding to all the possible answers to the questionnaire and columns corresponding to all the values of the output parameters and wherein every element of the scoring matrix is either a zero or a fraction, and when an answer is chosen, the matrix is reduced by eliminating the rows of the not chosen answers, and when all questions have been answered, the total sum of each column provides a fractional value lower than 1 for each level of output parameters with the algorithm being configured to select values with higher value to assign to a final scoring to each parameter, when the set of scores is defined, the algorithm is configured to pick one of twelve main profiles, defined statistically as providing specific behavior characteristics wherein the client investor is matched with an existing risk category, or kept as a standalone profiling with each profile obtaining access to a subset of financial instruments predetermined as being are suitable with risk profile, time horizon and behavior characterization of the client investor.

3. A computer program on non-transitory computer readable media configured to implement the steps of the method of claim 1.
